(19) United States
(12) Patent Application Publication
(10) Pub. No.: US 2009/0233678 A1
(43) Pub. Date: Sep. 17, 2009

(54) Gaming System Having A Plurality Of Slot Machines Linked By Network And Control Method Thereof

(75) Inventor: Tomoaki Oomori, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/144,149

(22) Filed: Jun. 23, 2008

Related U.S. Application Data
(60) Provisional application No. 61/037,082, filed on Mar. 17, 2008.

(51) Int. Cl. A63F 9/24; A63F 13/00

(52) U.S. Cl. 463/20

(57) ABSTRACT

A gaming system of the present invention comprises: plural slot machines each including a symbol display, and a controller; a control device having a processor; and a network, the controller programmed to execute the processing of executing repeatedly processing of stop-displaying the plurality of symbols after variably displaying to the symbol display, the processor programmed to execute the processing of counting cumulatively a number of a specific game in which the plurality of symbols stop-displayed to the symbol display of each slot machine or a combination of the plurality of symbols is in a specific state, and transmitting a payout signal to the slot machines when the number of the specific game has reached a predetermined number, and the controller further programmed to execute the processing of conducting a payout of game media when receiving the payout signal.

### CROSS-REFERENCE TO RELATED APPLICATIONS

This application claims benefit of priority based on U.S. Provisional Patent Application Ser. No. 61/037,082 filed on Mar. 17, 2008. The contents of this application are incorporated herein by reference in their entirety.

### BACKGROUND OF THE INVENTION

1. Field of the Invention

The present invention relates to a gaming system having a plurality of slot machines linked by network and a control method thereof.

2. Discussion of the Background

Conventionally, there exists a gaming system having a plurality of gaming machines linked by network as disclosed in: U.S. Pat. No. 6,068,553, U.S. Pat. No. 6,210,275, U.S. Pat. No. 6,224,484, US 2003/0236110-A1, US 2005/0079911-A1, US 2005/0119044-A1, US 2006/0205468-A1, US 2005/0187014-A1, US 2006/0287043-A1, US 2006/0073897-A1, US 2007/0087824-A1, US 2007/0167217-A1. In this kind of a gaming system, a game medium inserted into each gaming machine is pooled in one place and the pooled game medium is paid out to the gaming machine having won a progressive jackpot.

In the above-described gaming system, the pooled gaming medium is to be scrambled among players playing on a plurality of gaming machines, which are mutually linked. Therefore, fellowship is hardly formed among players playing on respective gaming machines. In particular, in the above-described gaming machine, there has been a problem that it is highly possible for the player to feel mental isolation as the player mostly play the game alone.

The present invention has been devised to solve the above problem and an object thereof is to provide a gaming system capable of relieving the loneliness of the players by forming the fellowship among the players playing on the slot machines linked by a link system, and a control method thereof.

The contents of U.S. Pat. No. 6,068,553, U.S. Pat. No. 6,210,275, U.S. Pat. No. 6,224,484, US 2003/0236110-A1, US 2005/0079911-A1, US 2005/0119044-A1, US 2006/0205468-A1, US 2005/0187014-A1, US 2006/0287043-A1, US 2006/0073897-A1, US 2007/0087824-A1, US 2007/0167217-A1 are incorporated herein by reference in their entirety.

### SUMMARY OF THE INVENTION

The present invention provides a gaming system having the following configuration.

Namely, the gaming system comprises: a plurality of slot machines each provided with a symbol display capable of variably displaying a plurality of symbols, and a controller; a control device provided with a processor; and a network enabling a communication between the plurality of slot machines and the control device. The controller is programmed to execute the processing of (a) executing repeatedly processing of stop-displaying the plurality of symbols after variably displaying the plurality of symbols, to the symbol display. The processor is programmed to execute the processing of (A) counting cumulatively a number of a specific game in which the plurality of symbols stop-displayed to the symbol display of each of the slot machines or a combination of the plurality of symbols is in a specific state, and (B) transmitting a payout signal to the slot machines when the number of the specific game has reached a predetermined number. The controller is further programmed to execute the processing of (b) conducting a payout of a predetermined number of game media when receiving the payout signal from the control device.

According to the gaming system, in the control device, there is cumulatively counted the number of the specific game in which symbols stop-displayed to the symbol display of each of the slot machines or the combination thereof is in a specific state. Then, when the number of the specific game has reached the predetermined number, a payout signal is transmitted to the slot machines. In each of the slot machines, payout of a predetermined number of game media is conducted when the payout signal is received from the control device. Accordingly, it becomes possible to form fellowship among the players playing on the respective slot machines, to cooperate to make the number of the specific game reach the predetermined number. Consequently, it becomes possible to relieve the loneliness.

It is desirable that the gaming system further has the following configuration.

The controller is further programmed to execute the processing of (a-1) transmitting a count signal to the control device, in a case where the plurality of symbols stop-displayed to the symbol display or the combination of the plurality of symbols is in the specific state. The processing (A) executed by the processor is a processing of counting cumulatively the number of the specific game based on receipt of the count signal.

According to the gaming system, the count signal is transmitted to the control device in a case where the symbols stop-displayed to the symbol display of each of the slot machines or the combination thereof is in the specific state. In the control device, the number of the specific game is cumulatively counted, based on receipt of the control signal. Namely, the count signal is transmitted to the control device, only in a case where a stop state of the symbols is a specific state in the slot machine. Accordingly, a load on the control device caused by counting processing of the number of the specific game can be reduced. As a result, it becomes possible to connect more slot machines with the control device.

It is desirable that the gaming system further has the following configuration.

The processing (a) executed by the controller is a processing of executing repeatedly processing of stop-displaying the plurality of symbols after variably displaying the plurality of symbols, to the symbol display, on condition that the game media is BET in number equal to or less than the predetermined maximum number of BET, and the processing (A) executed by the processor is a processing of counting cumulatively the number of the specific game in which the game media is BET in number equal to the maximum number of BET and the plurality of symbols stop-displayed to the symbol display or a combination of the plurality of symbols is in a specific state, in each of the slot machines.

According to the gaming system, there is cumulatively counted the number of the specific game in which the game media is BET in number equal to the maximum number of BET and the stop state of the symbols is the specific state. Accordingly, it is possible to encourage the player to BET the game media in the maximum number of BET to play a game. As a result, it becomes possible for the management side of a recreation hall to increase the possibility to make more profit in a short time.

The present invention further provides a gaming system having the following configuration.

Namely, the game system comprises: a plurality of slot machines each including a symbol display capable of variably displaying a plurality of symbols, and a controller; a control device provided with a processor; and a network enabling a communication between the plurality of slot machines and the control device. The controller is programmed to execute the processing of (a) executing repeatedly processing of stop-displaying the plurality of symbols after variably displaying the plurality of symbols, to the symbol display. The processor is programmed to execute the processing of (A) counting cumulatively a number of a specific game in which the plurality of symbols stop-displayed to the symbol display of each of the slot machines or a combination of the plurality of symbols is in a specific state, and (B) transmitting a payout signal to all of the plurality of slot machines when the number of the specific game has reached a predetermined number. The controller is further programmed to execute the processing of (b) conducting a payout of a predetermined number of game media when receiving the payout signal from the control device.

According to the gaming system, in the control device, there is cumulatively counted the number of the specific game in which symbols stop-displayed to the symbol display of each of the slot machines or the combination thereof is in a specific state. Then, when the number of the specific game has reached the predetermined number, a payout signal is transmitted to all the plurality of slot machines. In each of the slot machines, payout of a predetermined number of game media is conducted when the payout signal is received from the control device. Accordingly, it becomes possible to form fellowship among the players playing on the respective slot machines, to cooperate to make the number of the specific game reach the predetermined number. Consequently, it becomes possible to relieve the loneliness.

Further, payout of the predetermined number of game media is conducted in all the slot machines when the number of the specific game has reached the predetermined number. Therefore, it becomes possible for the players playing on the respective slot machines to share the delight.

The present invention further provides a gaming system having the following configuration.

Namely, the gaming system comprises: a plurality of slot machines each including a symbol display capable of variably displaying a plurality of symbols, and a controller; a control device provided with a processor; and a network enabling a communication between the plurality of slot machines and the control device. The controller is programmed to execute the processing of (a) executing repeatedly processing of stop-displaying the plurality of symbols after variably displaying the plurality of symbols, to the symbol display. The processor is programmed to execute the processing of (A) counting cumulatively a number of a specific game in which the plurality of symbols stop-displayed to the symbol display of each of the slot machines or a combination of the plurality of symbols is in a specific state, and (B) transmitting, when the number of the specific game has reached a predetermined number, a payout signal to the slot machine having executed the game which makes the number of the specific game reach the predetermined number. The controller is further programmed to execute the processing of (b) conducting a payout of a predetermined number of game media when receiving the payout signal from the control device.

According to the gaming system, in the control device, there is cumulatively counted the number of the specific game in which symbols stop-displayed to the symbol display of the respective slot machines or the combination thereof is in a specific state. Then, when the number of the specific game has reached the predetermined number, a payout signal is transmitted to the slot machine having executed the game which makes the number of the specific game reach the predetermined number. In each of the slot machines, payout of a predetermined number of game media is conducted when the payout signal is received from the control device. Accordingly, it becomes possible to form fellowship among the players playing on the respective slot machines, to cooperate to make the number of the specific game reach the predetermined number. Consequently, it becomes possible to relieve the loneliness.

Further, payout of the predetermined number of game media is conducted in the slot machine having executed the game which makes the number of the specific game reach the predetermined number, and therefore, it becomes possible to give a sense of superiority to the player playing on the slot machine having played the game which make the number of the specific game reach the predetermined number.

The present invention further provides a game control method having the following configuration.

Namely, the game control method comprises the steps of (a) executing in a slot machine repeatedly processing of stop-displaying a plurality of symbols after variably displaying the plurality of symbols, to the symbol display, (A) counting in a control device cumulatively a number of a specific game in which the plurality of symbols stop-displayed to the symbol displays of the respective slot machines or a combination of the plurality of symbols is in a specific state, (B) transmitting from the control device a payout signal to the slot machine when the number of the specific game has reached a predetermined number, and (b) conducting a payout of a predetermined number of game media in the slot machine when receiving the payout signal from the control device.

According to the game control method, in the control device, there is cumulatively counted the number of the specific game in which symbols stop-displayed to the symbol display of each of the slot machines or the combination thereof is in a specific state. Then, when the number of the specific game has reached the predetermined number, a payout signal is transmitted to the slot machine. In the slot machine, payout of a predetermined number of game media is conducted when the payout signal is received from the control device. Accordingly, it becomes possible to form fellowship among the players playing on the respective slot machines, to cooperate to make the number of the specific game reach the predetermined number. Consequently, it becomes possible to relieve the loneliness.

As just described, it become possible to provide a gaming system capable of relieving the loneliness of the players by forming the fellowship among the players playing on the slot machines linked by a link system, and a control method thereof.

### BRIEF DESCRIPTIONS OF DRAWINGS

FIG. 1 is a flowchart illustrating counting processing executed in a link system according to one embodiment of the present invention.

FIG. 2 is a perspective view schematically showing a link system according to one embodiment of the present invention.

FIG. 3A is an exemplary view of an image displayed to a common image display provided in the link system shown in FIG. 2.

FIG. 3B is another exemplary view of an image displayed to a common image display provided in the link system shown in FIG. 2.

FIG. 3C is another exemplary view of an image displayed to a common image display provided in the link system shown in FIG. 2.

FIG. 4 is a perspective view schematically showing a slot machine according to one embodiment of the present invention.

FIG. 5 is a block diagram illustrating the internal configuration of the slot machine shown in FIG. 4.

FIG. 6 is an explanatory view of a payout table in the present embodiment.

FIG. 7 is a block diagram illustrating the internal configuration of a control device provided in the link system shown in FIG. 2.

FIG. 8 is an explanatory view of a specific combination.

FIG. 9 is an explanatory view of a count value to be stored in RAM.

FIG. 10 is a flowchart illustrating main processing conducted in the slot machine shown in FIG. 4.

FIG. 11 is a flowchart illustrating a subroutine of game execution processing.

FIG. 12 is a chart illustrating a procedure of activation processing executed by the mother board and the gaming board shown in FIG. 5.

FIG. 13 is a chart illustrating a procedure of peripheral-device initialization processing.

FIG. 14 is a chart illustrating a procedure of activation processing of a control device.

FIG. 15 is a flowchart illustrating a subroutine of to-be-stopped symbol determination processing.

FIG. 16 is a flowchart illustrating a subroutine of reel rotation control processing.

FIGS. 17A to 17D are side views for explaining the reel rotation.

FIG. 18 is a schematic view showing a correspondence table of the number of steps and code No.

FIG. 19A is an exemplary view of an image displayed to a common image display provided in a link system according to another embodiment of the present invention.

FIG. 19B is another exemplary view of an image displayed to a common image display provided in a link system according to another embodiment of the present invention.

FIG. 19C is another exemplary view of an image displayed to a common image display provided in a link system according to another embodiment of the present invention.

FIG. 20 is a perspective view schematically showing a slot machine according to another embodiment of the present invention.

### DESCRIPTION OF THE EMBODIMENTS

First, there will be described counting processing executed in a link system according to one embodiment of the present invention.

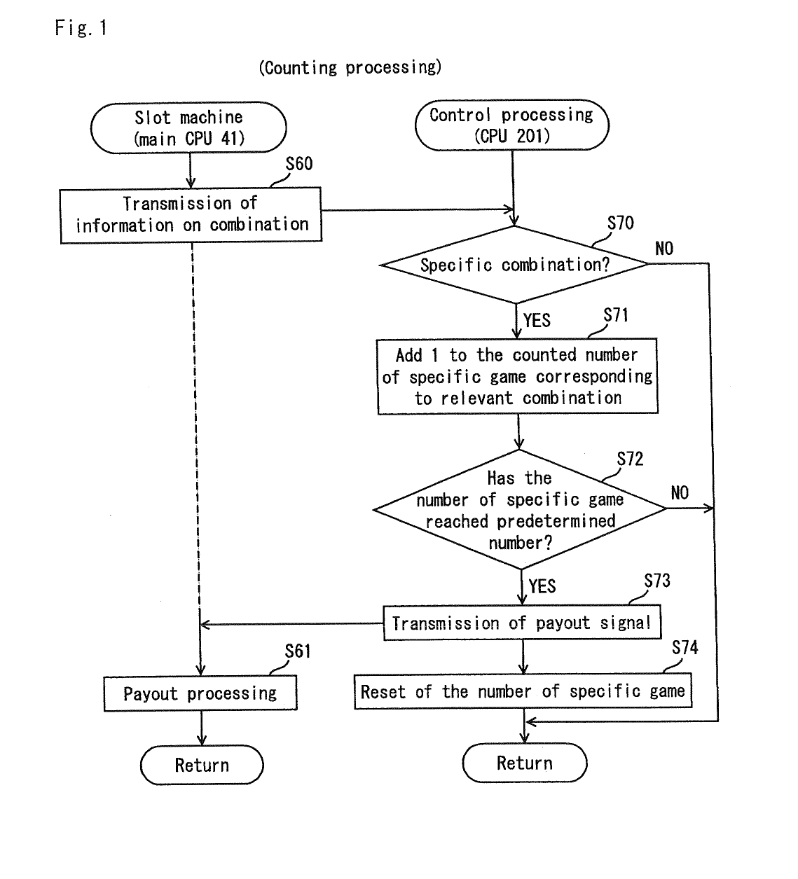

FIG. 1 is a flowchart illustrating counting processing executed in a link system according to one embodiment of the present invention.

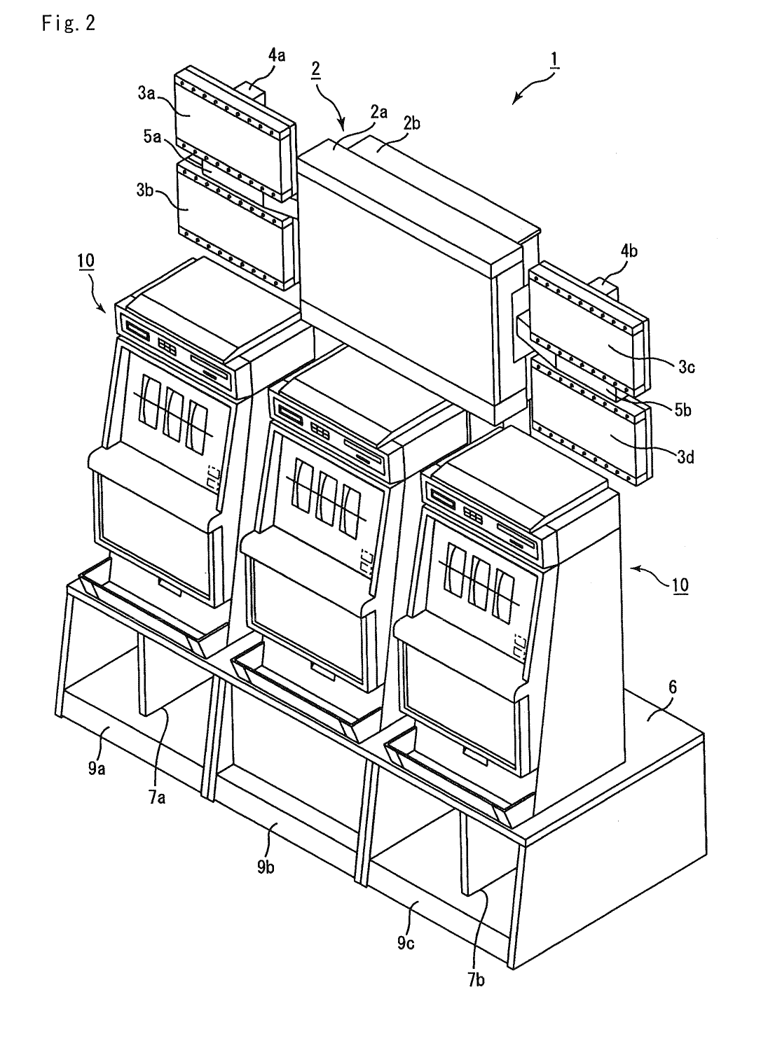

FIG. 2 is a perspective view schematically showing a link system according to one embodiment of the present invention.

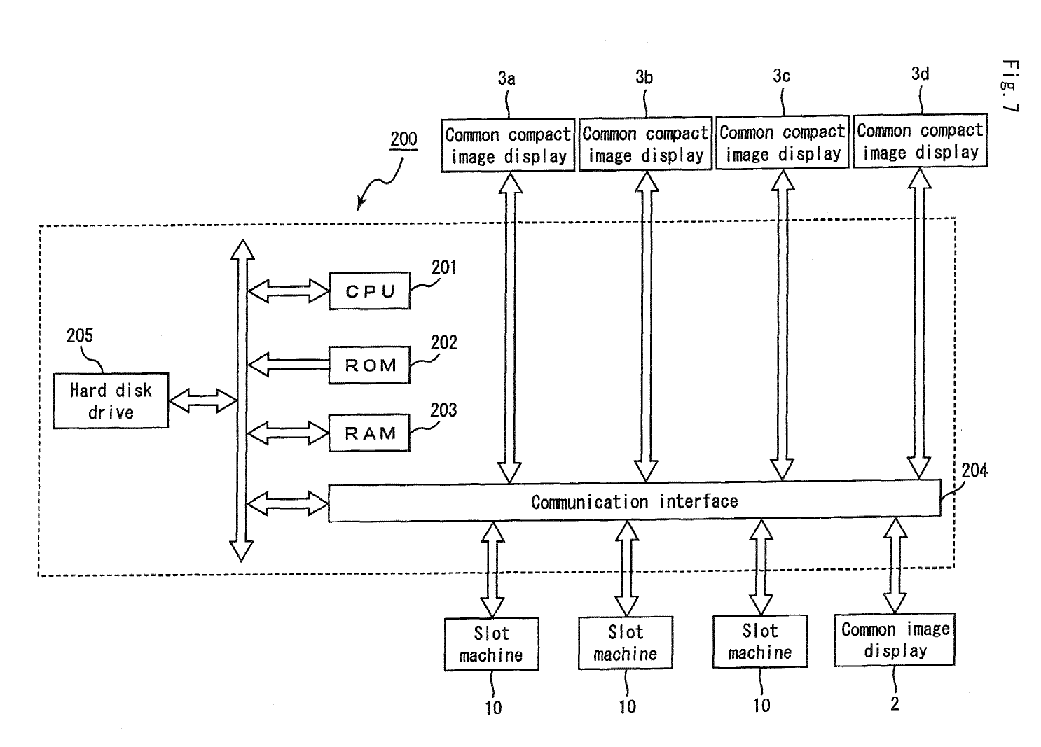

As shown in FIG. 2, a link system 1 is provided with a plurality of slot machines 10 (three, in the present embodiment), a control device 200 (see FIG. 7), and a common image display 2, which are mutually connected by network.

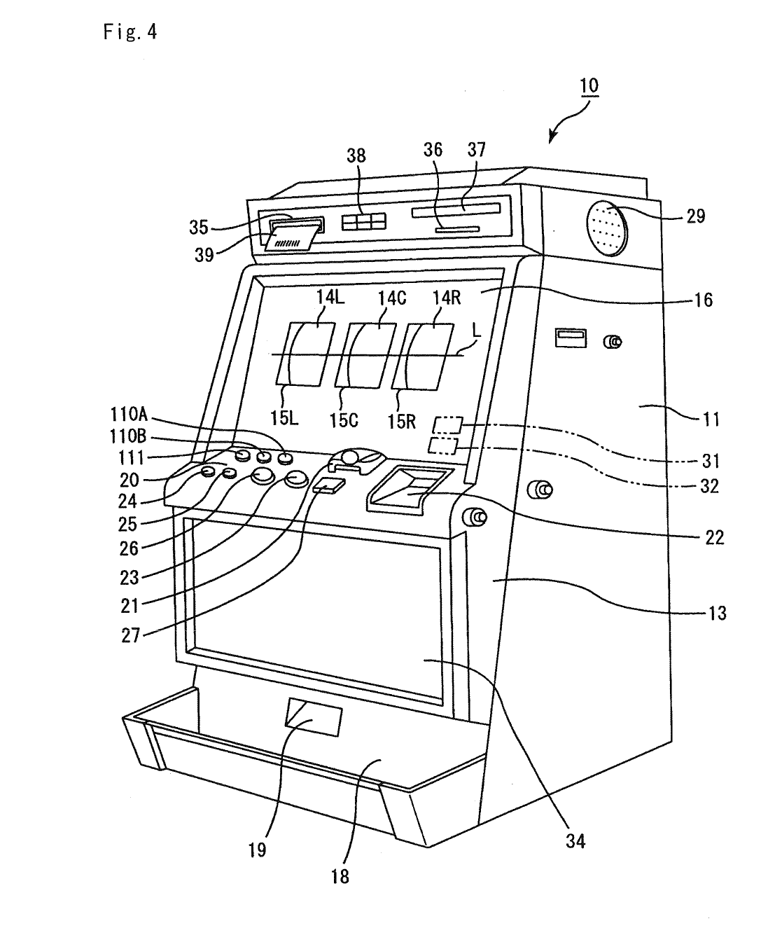

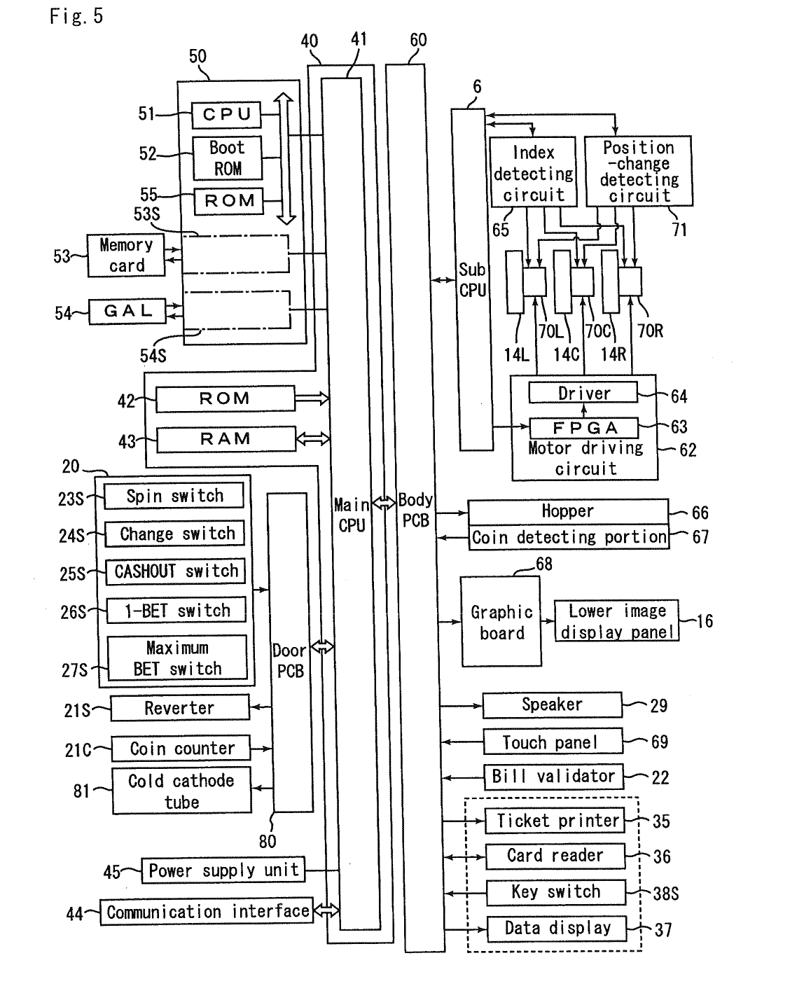

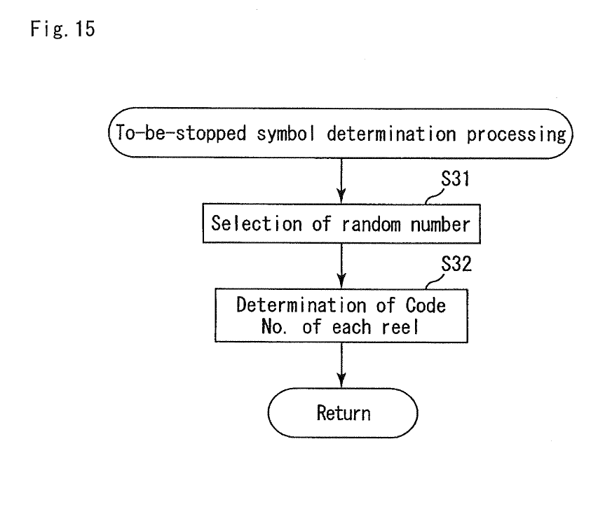

In a main CPU 41 (see FIG. 5) provided in the slot machine 10, code No. of each reel 14 (see FIG. 4) is determined in to-be-stopped symbol determination processing (see step S32 in FIG. 15). Here, in the slot machine 10, each rotating reel 14 is stopped based on the determined code No. at a predetermined position.

In the counting processing shown in FIG. 1, the main CPU 41 first transmits information (hereinafter, also referred to as “information on combination”) on the code No. of each reel 14 determined in the to-be-stopped symbol determination processing to a CPU 201 (see FIG. 7) provided in the control device 200 (step S60).

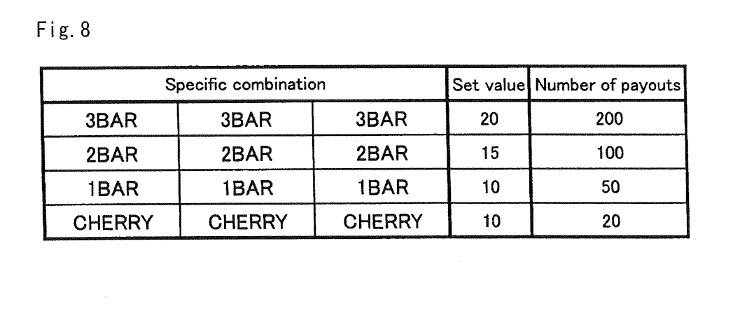

On receiving the information on combination, the CPU 201 determines whether or not the combination shown by the received information is a specific combination (step S70). Here, in the present embodiment, the specific combinations refers to “3BAR-3BAR-3BAR”, “2BAR-2BAr-2BAR”, “1BAR-1BAR-1BAR”, and “CHERRY-CHERRY-CHERRY” (see FIG. 8). The specific combination corresponds to the specific state of the present invention. When determining the combination is not the specific combination, the CPU 201 terminates the present subroutine.

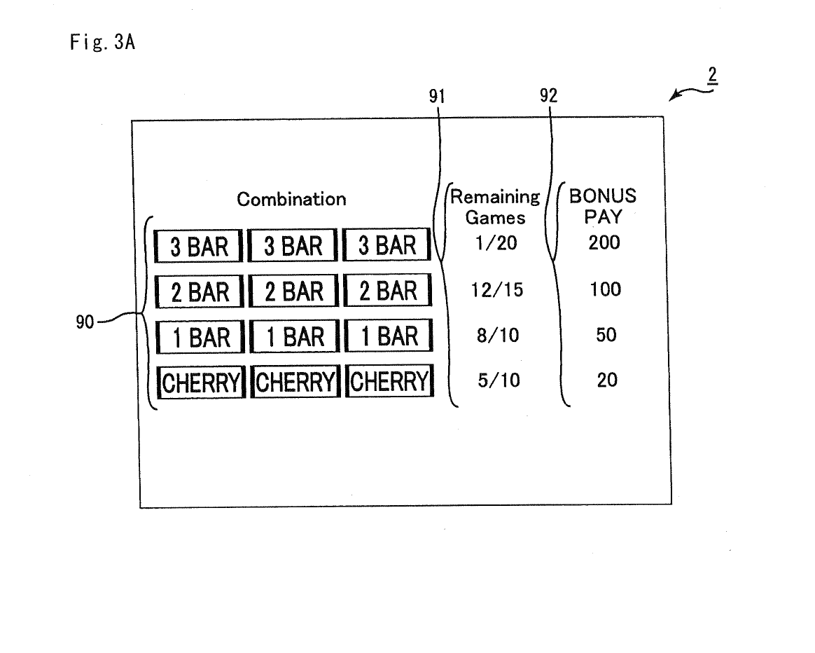

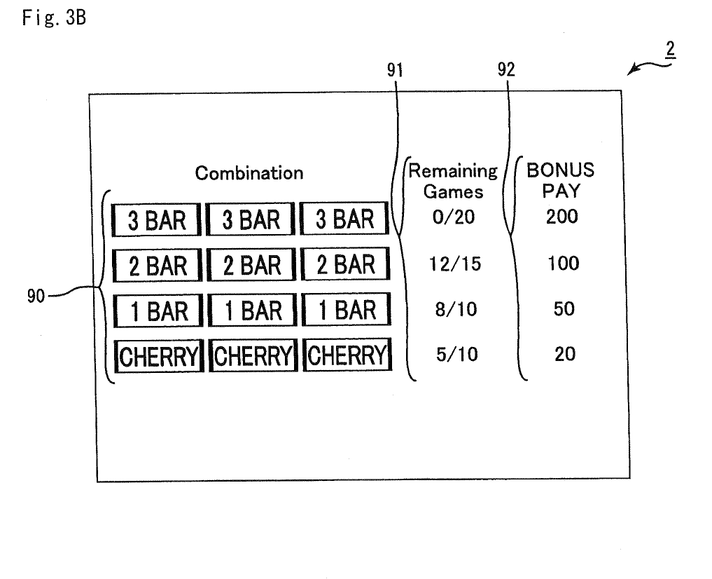

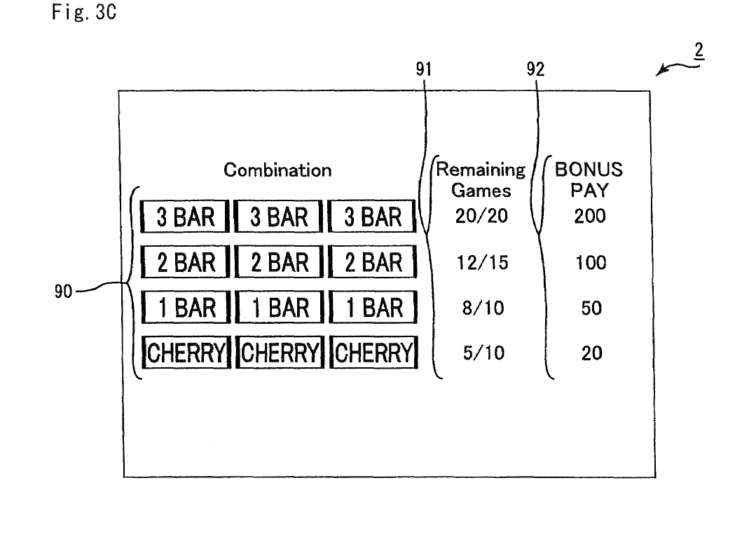

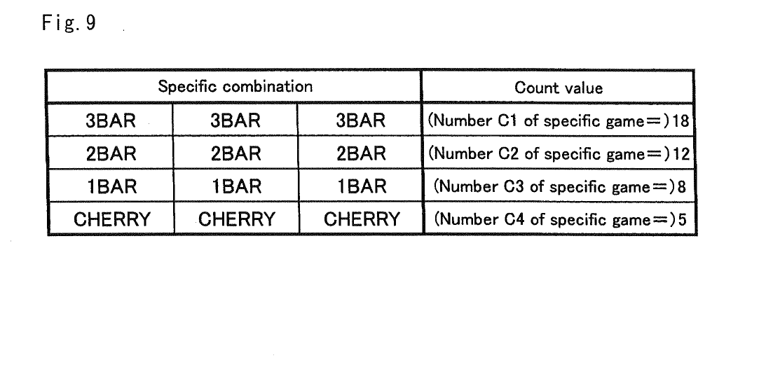

When determining that the combination is the specific combination in step S70, the CPU 201 adds “1” to the number of the specific game corresponding to the relevant specific combination (step S71). For example, when the received information on combination is “3BAR-3BAR-3BAR”, the CPU 201 adds “1” to the number of the specific game corresponding to “3BAR-3BAR-3BAR” (see FIG. 9). At this time, the CPU 201 updates display of the number of remaining games (for example, see FIG. 3A) to the common image display 2.

Next, in step S73, the CPU 201 determines whether or not the number of the specific game has reached a predetermined number (set value). Namely, the CPU 201 determines whether or not the number of the specific game has reached the predetermined set value (see FIG. 8), for each type of the specific combinations. When determining that the number of the specific game has not reached the predetermined number, the CPU 201 terminates the present subroutine.

When determining that the number of the specific game has reached the predetermined number in step S72, the CPU 201 transmits a payout signal for instructing to pay out coins in number corresponding to the type of the specific combination having reached the predetermined number, to the main CPU 41 provided in the slot machine 10 (step S73). For example, in the case that the number C1 of the specific game corresponding to “3BAR-3BAR-3BAR” has reached the predetermined number, the CPU 201 transmits the payout signal for instructing to pay out 360 coins (see FIG. 8), to the main CPU 41 of three slot machines 10 connected to the link system 1.

Next, in step S74, the CPU 201 resets the number of the specific game corresponding to the specific combination having reached the predetermine number. For example, in the case that the number C1 of the specific game corresponding to “3BAR-3BAR-3BAR” has reached the predetermined number, the CPU 201 resets only the number C1 of the specific game. Then, the CPU 201 terminates the present subroutine.

On the other hand, on receiving the payout signal from the CPU 201, the main CPU 41 pays out coins in number based on the received payout signal (step S61) and terminates the present subroutine.

According to the link system 1, in the control device 200, there is cumulatively counted the number of the specific game in which a combination of symbols stop-displayed to the reels 14 of each of the slot machines 10 is a specific combination. Then, when the number of the specific game has reached the predetermined number, a payout signal is transmitted to the slot machines 10. In each of the slot machines 10, payout of coins in predetermined number is conducted when the payout signal is received from the control device 200. Accordingly, it becomes possible to form fellowship among the players playing on the respective slot machines 10, to cooperate to make the number of the specific game reach the predetermined number. Consequently, it becomes possible to relieve the loneliness.

Further, according to the link system 1, payout of the predetermined number of coins is conducted in all the slot machines 10 (three, in the present embodiment) when the number of the specific game has reached the predetermined number. Therefore, it becomes possible for the players playing on the respective slot machines 10 to share the delight.

Next, there will be described the link system 1 in detail.

As shown in FIG. 2, the link system 1 is provided with a base 6, three slot machines 10 mounted on the base 6, the common image display 2 supported onto a supporting member (not shown) so as to be positioned above the upper face of the slot machines 10, common compact image displays 3 (common compact image display 3a, common compact image display 3b, common sand compact image display 3c) mounted via fixing members 4 (fixing member 4a, fixing member 4b) onto sub supporting members 5 (sub supporting member 5a, sub supporting member 5b) extended to the right and left side from the common image display 2, and the control device 200 (not shown).

The link system 1 corresponds to the gaming system of the present invention. Here, in the present invention, it is not required to have the plurality of slot machines established in parallel as shown in FIG. 2, as long as the slot machines provided in the gaming system are communicably connected to the control device via network. For example, the slot machines provided in the gaming system of the present invention may be respectively installed in a plurality of casinos and may be communicably connected via network to the control device installed in any one of casinos.

The base 6 is provided with leg portions 9 (leg portion 9a, leg portion 9b, leg portion 9c) and a housing area having an opening front face at the bottom portion of the base 6. In the housing area, the control device 200 (not shown) is housed. Further, in the housing are, there are provided plate-shaped base supporting members 7 (base supporting member 7a, base supporting member 7b), which is perpendicular to the bottom face of the base 6, to enhance the strength of the base 6.

Here, the slot machines 10, the common image display 2, and the common compact image displays 3 are communicably connected to the control device 200 by a communication cable laid in the space provided inside the base 6, the supporting member, and the sub supporting members 5.

FIG. 3A, FIG. 3B, and FIG. 3C are exemplary views of images displayed to a common image display provided in the link system shown in FIG. 2.

As shown in FIG. 3A, to the common image display 2, there are provided an area 90 for displaying “Combination”, an area 91 for displaying “Remaining Games”, and an area 92 for displaying “BONUS PAY”. “Combination” displayed in the area 90 indicates a specific combination.

“Remaining Games” shows the required number (set value) of establishment of the specific game for the payout of the coin as “BONUS PAY” and the number of remaining games for “BONUS PAY”. For example, in FIG. 3A, “Remaining Games” of “3BAR-3BAR-3BAR” is 1/20. “20” of the denominator indicates that the required number of establishment of the specific game for “BONUS PAY” is 20. “1” of the denomination indicates that the number of remaining games for “BONUS PAY” is 1. Here, in FIG. 3A, the combination of “3BAR-3BAR-3BAR” has been established for 19 times, so that the number of remaining games is 1. Here, the set value corresponds to the predetermined number of the present invention.

“BONUS PAY” shows the number of coins to be paid out when the number of establishment of the specific combination reaches the set value, that is, the number of remaining games becomes 0.

In a state shown in FIG. 3A, when the combination of “3BAR-3BAR-3BAR”, for example, is established at any of the three slot machines 10, the number of the specific game corresponding to the combination of “3BAR-3BAR-3BAR” reaches the predetermined number (20 times) (see FIG. 3B).

As a result, 360 coins as “BONUS PAY” of “3BAR-3BAR-3BAR” are to be paid out at all of three slot machines 10.

Thereafter, the number of the specific game of “3BAR-3BAR-3BAR” is reset, and as shown in FIG. 3C, “Remaining Games” of “3BAR-3BAR-3BAR” is displayed as 20/20. Here, in the present embodiment, the number of the specific game corresponding to the specific combination having not reached the predetermined number is not reset.

FIG. 4 is a perspective view schematically showing a slot machine according to one embodiment of the present invention.

In the slot machine 10, a coin, a bill, or electronic valuable information corresponding to those is used as a game medium. However, in the present invention, the game medium is not particularly limited. Examples of the game medium may include a medal, a token, electronic money and a ticket. It is to be noted that the ticket is not particularly limited, and examples thereof may include a ticket with a barcode as described later.

The slot machine 10 comprises a cabinet 11, a top box 12 installed on the upper side of the cabinet 11, and a main door 13 provided at the front face of the cabinet 11. Inside the cabinet 11, three reels 14 (14L, 14C, 14R) are rotatably provided. On the peripheral face of each of the reels 14, a symbol sequence consisting of 22 figures (hereinafter also referred to as symbols) is drawn.

The reels 14 correspond to the symbol display of the present invention.

A lower image display panel 16 is provided at the front of the respective reels 14 on the main door 13. The lower image display panel 16 is provided with a transparent liquid crystal panel to which a variety of information concerning a game, an effect image and the like are displayed during the game.

On the lower image display panel 16, three display windows 15 (15L, 15C, 15R) are formed in which their back faces are visible, and three symbols drawn on the peripheral face of each of the reels 14 are displayed via each of the display windows 15. On the lower image display panel 16, one winning line L horizontally crossing over the three display windows 15 is formed. The winning line L is for determining a combination of symbols. When the combination of symbols that are rearranged along the winning line L is a predetermined combination, coins are paid out in number according to the combination and the number of inserted coins (the number of BETs).

In the present invention, it may be possible to provide a configuration such that, for example, there are formed a plurality of winning lines L crossing horizontally or diagonally over the three display windows 15, and the winning lines L in number according to the number of inserted coins are verified, and when a combination of symbols rearranged along the verified winning line L is a predetermined combination, coins are paid out in number according to the combination.

Further, when a specific symbol (so-called scatter symbol) is rearranged to the display window, coins may be paid out in number according to the number of the symbol regardless of the combination of symbols.

Moreover, although not shown, a touch panel 69 is provided at the front face of the lower image display panel 16. The player can operate the touch panel 69 to input a variety of commands.

Below the lower image display panel 16, there are provided a control panel 20 including a plurality of buttons 23 to 27 with each of which a command according to game progress is inputted by the player, a coin receiving slot 21 through which a coin is accepted into the cabinet 11, and a bill validator 22.

The control panel 20 is provided with a spin button 23, a change button 24, a CASHOUT button 25, a 1-BET button 26 and a maximum BET button 27. The spin button 23 is used for inputting a command to start rotation of the reels 14. The change button 24 is used for making a request of staff in the recreation facility for exchange. The CASHOUT button 25 is used for inputting a command to pay out credited coins to a coin tray 18.

The 1-BET button 26 is used for inputting a command to bet one coin on a game out of credited coins. The maximum BET button 27 is used for inputting a command to bet the maximum number of coins that can be bet on one game (three coins in the present embodiment) out of credited coins. In addition, the maximum number of BETs may be configured so as to be set by the operator, staff or the like of the casino.

The bill validator 22 not only discriminates a regular bill from a false bill, but also accepts the regular bill into the cabinet 11. It is to be noted that the bill validator 22 may be configured so as to be capable of reading a later-described ticket 39 with a barcode. At the lower front of the main door 13, namely, below the control panel 20, there is provided a belly glass 34 on which a character or the like of the slot machine 10 is drawn.

Also, speakers 29 are provided on either side of the top box 12. Further, on the front face of the top box 12, there are provided a ticket printer 35, a card reader 36 (see FIG. 4), a data display 37, and a key pad 38. The ticket printer 35 prints on a ticket a barcode as coded data of the number of credits, a date, an identification number of the slot machine 10, and the like, and outputs the ticket as the ticket 39 with a barcode. The player can make another slot machine read the ticket 39 with a barcode to play a game thereon, or exchange the ticket 39 with a barcode with a bill or the like at a predetermined place in the recreation facility (e.g. a cashier in a casino).

The card reader 36 reads data from a smart card inserted into the card slot 36a and writes data into the smart card. The smart card is a card owned by the player, and for example, data for identifying the player (identification data) and data concerning a history of games played by the player are stored therein. Data corresponding to a coin, a bill or a credit may be stored in the smart card. Further, a magnetic stripe card may be adopted in place of the smart card. The data display 37 includes a fluorescent display and the like, and displays, for example, data read by the card reader 36 or data inputted by the player via the key pad 38. The key pad 38 is used for inputting a command and data concerning issuing of a ticket, and the like.

FIG. 5 is a block diagram showing the internal configuration of the slot machine shown in FIG. 4.

A gaming board 50 is provided with a CPU (Central Processing Unit) 51, a ROM 55, and a boot ROM 52 which are interconnected to one another by an internal bus, a card slot 53S corresponding to a memory card 53, and an IC socket 54S corresponding to a GAL (Generic Array Logic) 54.

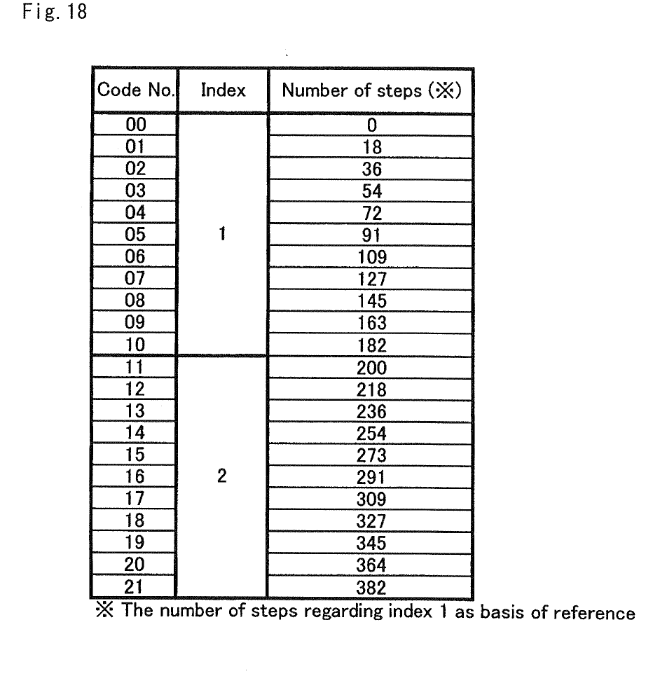

The memory card 53 includes a nonvolatile memory such as CompactFlash (registered trade mark), and stores a game program and a game system program. The game program includes a to-be-stopped symbol determination program. The to-be-stopped symbol determination program is a program for determining a symbol (code No. corresponding to the symbol) on each of the reels 14 to be rearranged along the winning line L. The to-be-stopped symbol determination program includes symbol weighing data respectively corresponding to a plurality of types of payout ratios (e.g. 80%, 84%, 88%). The symbol weighing data is data showing the corresponding relation between code No. (see FIG. 18) of each symbol and one or a plurality of random numbers belonging to a predetermined numerical range (0 to 255), for each of the three reels 14. The payout ratio is set based on payout ratio setting data which is outputted from the GAL 54, and a symbol to be rearranged is determined based on the symbol weighing data corresponding to the payout ratio.

Further, the card slot 53S is configured so as to allow the memory card 53 to be inserted thereinto or removed therefrom, and is connected to the mother board 40 by an IDE bus. Therefore, the memory card 53 can be removed from the card slot 53S, and then another game program and another game system program are written into the memory card 53, and the memory card 53 can be inserted into the card slot 53S, to change the type and contents of a game played on the slot machine 10. Further, the memory card 53 storing one game program and one game system program can be exchanged with the memory card 53 storing another game program and another game system program, to change the type and contents of a game played on the slot machine 10.

The game program includes a program according to progress of the game. Further, the game program includes image data and sound data to be outputted during the game.

The GAL 54 is a type of a PLD having an OR fixed type array structure. The GAL 54 is provided with a plurality of input ports and output ports. When predetermined data is inputted to the input port, the GAL 54 outputs, from the output port, data corresponding to the inputted data. The data outputted from the output port is the above-mentioned payout ratio setting data.

Further, the IC socket 54S is configured such that the GAL 54 can be mounted thereon and removed therefrom, and the IC socket 54S is connected to the mother board 40 through the PCI bus. Therefore, the GAL 54 can be removed from the IC socket 54S, and then a program to be stored into the GAL 54 is rewritten, and the GAL 54 is then mounted onto the IC socket 54S, to change the payout ratio setting data outputted from the GAL 54. Further, the GAL 54 can be exchanged with another GAL 54 to change the payout ratio setting data.

The CPU 51, the ROM 55 and the boot ROM 52 interconnected to one another by an internal bus are connected to the mother board 40 through the PCI bus. The PCI bus not only conducts signal transmission between the mother board 40 and the gaming board 50, but also supplies power from the mother board 40 to the gaming board 50. In the ROM 55, country identification information and an authentication program are stored. In the boot ROM 52, an auxiliary authentication program and a program (boot code) to be used by the CPU 51 for activating the auxiliary authentication program, and the like are stored.

The authentication program is a program (falsification check program) for authenticating a game program and a game system program. The authentication program is written along a procedure (authentication procedure) for checking and proving that a game program and a game system program to be subject to authentication loading processing have not been falsified, namely authenticating the game program and the game system program. The auxiliary authentication program is a program for authenticating the above-mentioned authentication program. The auxiliary authentication program is written along a procedure (authentication procedure) for proving that an authentication program to be subject to the authentication processing has not been falsified, namely, authenticating the authentication program.

The mother board 40 is configured using a commercially available general-purpose mother board (a print wiring board on which fundamental components of a personal computer are mounted), and provided with a main CPU 41, a ROM (Read Only Memory) 42, a RAM (RandomAccess Memory) 43, and a communication interface 44. The main CPU 41, the ROM 42 and the RAM 43 mounted on the mother board 40 constitute the controller of the present invention.

The ROM 42 comprises a memory device such as a flash memory, and stores a program such as a BIOS (Basic Input/Output System) executed by the main CPU 41 and permanent data. When the BIOS is executed by the main CPU 41, processing for initializing a predetermined peripheral device is conducted, concurrently with start of processing for loading the game program and the game system program stored in the memory card 53 via the gaming board 50. It is to be noted that, in the present invention, the ROM 42 may or may not be data rewritable one.

The RAM 43 stores data and a program to be used at the time of operation of the main CPU 41. Further, the RAM 43 is capable of storing an authentication program to be read via the gaming board 50, a game program and a game system program.

Moreover, the RAM 43 stores data of the number of credits, the numbers of coin-ins and coin-outs in one game, and the like. The communication interface 44 serves to communicate with the control device 200, via the communication cable.

Moreover, the mother board 40 is connected with a later-described body PCB (Printed Circuit Board) 60 and a door PCB 80 through respective USBs. Further, the mother board 40 is connected with a power supply unit 45. When power is supplied from the power supply unit 45 to the mother board 40, the main CPU 41 of the mother board 40 is activated concurrently with supply of power to the gaming board 50 via the PCI bus to activate the CPU 51.

The body PCB 60 and the door PCB 80 are connected with an equipment and a device that generate an input signal to be inputted into the main CPU 41 and an equipment and a device operations of which are controlled by a control signal outputted from the main CPU 41. The main CPU 41 executes the game program and the game system program stored in the RAM 43 based on the input signal inputted into the main CPU 41, and thereby executes the predetermined arithmetic processing, stores the result thereof into the RAM 43, or transmits a control signal to each equipment and device as processing for controlling each equipment and device.

The body PCB 60 is connected with a sub CPU 61, a hopper 66, a coin detecting portion 67, a graphic board 68, the speaker 29, the touch panel 69, the bill validator 22, the ticket printer 35, the card reader 36, a key switch 38S and the data display 37.

The sub CPU 61 serves to control rotation and stop of the reels 14 (14L, 14C, 14R). A motor driving circuit 62 having an FPGA (Field Programmable Gate Array) 63 and a driver 64 is connected to the sub CPU 61. The FPGA 63 is an electronic circuit such as a programmable LSI, and functions as a control circuit of a stepping motor 70. The driver 64 functions as an amplification circuit of a pulse to be inputted into the stepping motors 70. The stepping motors 70 (70L, 70C, 70R) for rotating the respective reels 14 are connected to the motor driving circuit 62. The stepping motor 70 is a one-two phase excitation stepping motor.

In the present invention, the excitation method of the stepping motor is not particularly limited, and for example, a two phase excitation method, one phase excitation method or the like may be adopted. Further, a DC motor may be adopted in place of the stepping motor. In the case of adopting the DC motor, a deviation counter, a D/A converter, and a servo amplifier are sequentially connected to the sub CPU 61, and the DC motor is connected to the servo amplifier. Further, a rotational position of the DC motor is detected by a rotary encoder, and a current rotational position of the DC motor is supplied as data from the rotary encoder to the deviation counter.

Further, an index detecting circuit 65 and a position-change detecting circuit 71 are connected to the sub CPU 61. The index detecting circuit 65 detects the position (later-described index) of the reels 14 during rotation, and is further capable of detecting a loss of synchronism of the reels 14. Here, the control of rotation and stop of reels 14 will be described later in detail using the figures.

The position-change detecting circuit 71 detects the change of the stop positions of the reels 14, after the stop of the rotation of the reels 14. For example, the position-change detecting circuit 71 detects the change of the stop positions of the reels 14, in a case such that a player forcibly changes the stop positions of the reels 14 to create a combination of symbols in a winning state, even though the actual combination of symbols is not in the winning state, or in some other cases. The position-change detecting circuit 71 is configured, for example, to detect fins (not shown) mounted to the inner sides of the reels 14 at predetermined intervals so as to detect the change of the stop positions of the reels 14.

The hopper 66 is installed inside the cabinet 11, and pays out a predetermined number of coins based on the control signal outputted from the main CPU 41, from the coin payout exit 19 to the coin tray 18. The coin detecting portion 67 is provided inside the coin payout exit 19, and outputs an input signal to the main CPU 41 in the case of detecting payout of the predetermined number of coins from the coin payout exit 19.

The graphic board 68 controls image display to the lower image display panel 16 based on the control signal outputted from the main CPU 41. The number of credits stored in the RAM 43 is displayed to a number-of-credits display portion 31 of the lower image display panel 16. Further, the number of coin-outs is displayed to a number-of-payouts display portion 32 of the lower image display panel 16.

The graphic board 68 comprises a VDP (Video Display Processor) for generating image data based on the control signal outputted from the main CPU 41, a video RAM for temporarily storing image data generated by the VDP, and the like. It is to be noted that image data used in generation of the image data by the VDP is included in the game program read from the memory card 53 and stored into the RAM 43.

The bill validator 22 not only discriminates a regular bill from a false bill, but also accepts the regular bill into the cabinet 11. Upon acceptance of the regular bill, the bill validator 22 outputs an input signal to the main CPU 41 based on a face amount of the bill. The main CPU 41 stores in the RAM 43 the number of credits corresponding to the face amount of the bill transmitted with the input signal.

The ticket printer 35, based on the control signal outputted from the main CPU 41, prints on a ticket a barcode as coded data of the number of credits stored in the RAM 43, a date, and an identification number of the slot machine 10, and the like, and outputs the ticket as the ticket 39 with a barcode. The card reader 36 reads data from the smart card and transmits the read data to the main CPU 41, and writes data onto the smart card based on the control signal from the main CPU 41. The key switch 38S is provided on the keypad 38, and outputs a predetermined input signal to the main CPU 41 when the key pad 38 is operated by the player. The data display 37 displays data read by the card reader 36 and data inputted by the player via the key pad 38, based on the control signal outputted from the main CPU 41.

The door PCB 80 is connected with a control panel 20, a reverter 21S, a coin counter 21C, and a cold cathode tube 81. The control panel 20 is provided with a spin switch 23S corresponding to the spin button 23, a change switch 24S corresponding to the change button 24, a CASHOUT switch 25S corresponding to the CASHOUT button 25, a 1-BET switch 26S corresponding to the 1-BET button 26, and the maximum BET switch 27S corresponding to the maximum BET button 27. Each of the switches 23S to 27S outputs an input signal to the main CPU 41 when each of the buttons 23 to 27 corresponding thereto is operated by the player.

The coin counter 21C is provided inside the coin receiving slot 21, and discriminates a regular coin from a false coin inserted into the coin receiving slot 21 by the player. Coins other than the regular coin are discharged from the coin payout exit 19. Further, the coin counter 21C outputs an input signal to the main CPU 41 in detection of the regular coin.

The reverter 21S operates based on the control signal outputted from the main CPU 41, and distributes a coin recognized by the coin counter 21C as the regular coin into a cash box (not shown) or the hopper 66, which are disposed in the slot machine 10. Namely, when the hopper 66 is filled with coins, the regular coin is distributed into the cash box by the reverter 21S. On the other hand, when the hopper 66 is not filled with coins, the regular coin is distributed into the hopper 66. The cold cathode tube 81 functions as a back light installed on the rear face side of the lower image display panel 16, and is lit up based on the control signal outputted from the main CPU 41.

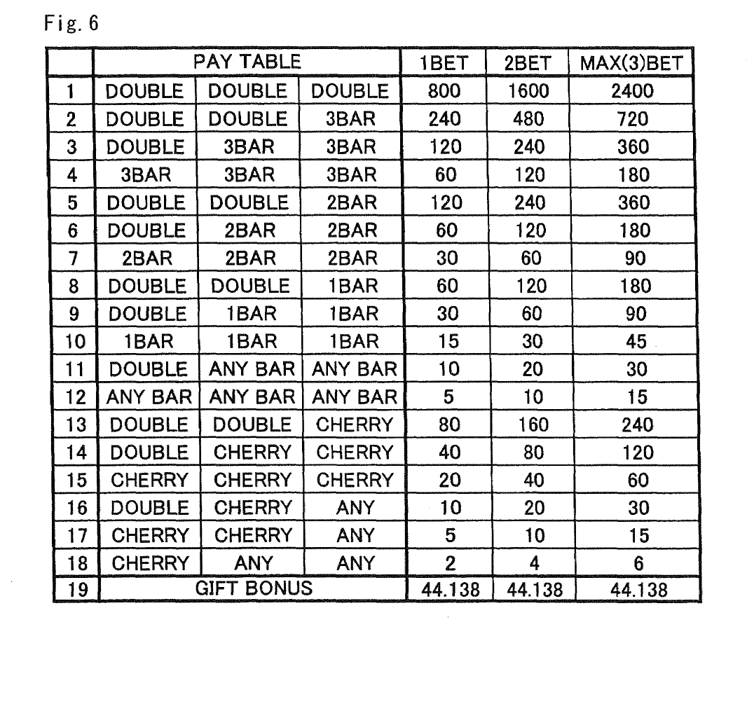

FIG. 6 is an explanatory view of a payout table in the present embodiment.

“DOUBLE”, “3BAR”, “2BAR”, “1BAR”, and “CHERRY” in the payout table represent types of symbols drawn on the reels 14. It is to be noted that, other than the above-mentioned symbols, a bonus trigger, which is a symbol corresponding to “GIFT BONUS”, and other symbols are also drawn on the reels 14. In the payout table, “ANY BAR” represents “3BAR”, “2BAR” or “1BAR”, and “ANY” represents an arbitrary symbol.

Combinations shown in the payout table represent winning combinations, and the number of coin-outs according to the numbers of BETs is set for each of the winning combinations.

When a combination of rearranged symbols on each of the reels 14, is the combination of “GIFT BONUS”, a predetermined number of coins is paid out as a jackpot. It is to be noted that a numeric value corresponding to “GIFT BONUS” in the payout table indicates an expectation value of the number of coin-outs, and is constant regardless of the number of BETs. Therefore, a setting is made such that the probability for establishing “GIFT BONUS” is high and the number of coin-outs is small in the case of 1BET, whereas the probability for establishing “GIFT BONUS” is low and the number of coin-outs is large in the case of the MAXBET. It should be noted that this probability setting is conducted by using the symbol weighing data.

Further, four types of jackpots “GRAND”, “MAJOR”, “MINOR” and “MINI” are provided in decreasing order of the number of coin-outs. The larger the number of coin-outs is, the lower the jackpot occurrence ratio is set, and which jackpot to be established is determined randomly using a random number. It should be noted that the expectation value of the number of coin-outs according to each jackpot is constant.

When a game is started by pressing of the spin button 23 after pressing of a 1-BET button 26 or a maximum BET button 27, the sequences of symbols drawn on the respective reels 14 are scroll-displayed downwardly in the display windows 15 with rotation of the reels 14, and after the lapse of a predetermined period of time, the sequences of symbols drawn on the respective reels 14 are rearranged in the display windows 15 with the stop of rotation of the reels 14. Further, a variety of winning combinations are previously set based on the respective combinations of symbols, and when the combination of symbols corresponding to the winning combination stops along the winning line L, the number of coin-outs according to the winning combination is added to credits owned by the player. When the combination of the bonus triggers of “GIFT BONUS” is established, a predetermined number of coin-outs is added to the credits owned by the player.

It should be noted that, in the present embodiment, there is described the case of paying out coins according to the jackpot when the combination of bonus triggers is established. However, the gaming state generated in establishment of the combination of bonus triggers is not particularly limited in the present invention. Examples of the gaming state may include a free game, a second game, and a mystery bonus. Further, when the combination of bonus triggers is established, the ticket 39 with a barcode may be issued with predetermined information printed thereon.

FIG. 7 is a block diagram illustrating the internal configuration of a control device provided in the link system shown in FIG. 2.

The control device 200 is provided with the CPU 201 as a processor, a ROM 202, a RAM 203, a communication interface 204, and a hard disk drive 205. The communication interface 204 is connected with the slot machine 10, the common image display 2, and the common compact image displays 3, via a communication cable. Here, the communication cable is a member forming the network of the present invention.

The ROM 202 stores a system program for controlling an operation of the control device 200, permanent data, and the like. Further, the ROM 202 includes a table (see FIG. 8) defining a correspondence of the specific combination, the number of payouts as “BONUS PAY”, and the set value.

The RAM 203 temporarily stores data such as data received from each slot machine 10 and data of a calculation result and the like. Further, the hard disk drive 205 stores information on the combination transmitted from each slot machine 10 and the number of the specific game counted for each specific combination.

The CPU 201 controls display of an image to the common image display 2, based on the number of the specific game counted in the counting processing. Accordingly, images shown in FIG. 3A to FIG. 3C, for example, are displayed to the common image display 2.

Further, the CPU 201 controls display of images to the common compact image displays 3. To the common compact image displays 3, for example, images showing introduction of game contents and explanation of a game rule are displayed under control of the CPU 201.

FIG. 8 is an explanatory view of a specific combination.

The specific combinations are, as already described, “3BAR-3BAR-3BAR”, “2BAR-2BAR-2BAR”, “1BAR-1BAR-1BAR”, and “CHERRY-CHERRY-CHERRY”. The specific combinations are respectively associated with the number of payouts as “BONUS PAY” and with the set value indicating the required number of establishment of the specific game for “BONUS PAY”. For example, the specific combination of “3BAR-3BAR-3BAR” is associated with the number of payouts of “360” and the set value of “20”.

In the ROM 202 of the control device 200, a table defining the correspondence of the specific combination, the number of payouts as “BONUS PAY”, and the set value, is included.

FIG. 9 is an explanatory view of a count value to be stored in RAM.

As shown in FIG. 9, in the RAM 203 provided in the control device 200, there is provided an area for storing the count value (the number C of the specific game) of the number of the specific game for each specific combination. For example, in FIG. 9, the count value of “3BAR-3BAR-3BAR” is “18”. This indicates that the value obtained by cumulatively counting the number of establishment of the combination “3BAR-3BAR-3BAR” in three slot machines 10 is “18”. Here, to the common image display 2, there is displayed 2/20, since the number of remaining games is two.

Next, processing conducted in the slot machine 10 is described.

### [Main Processing]

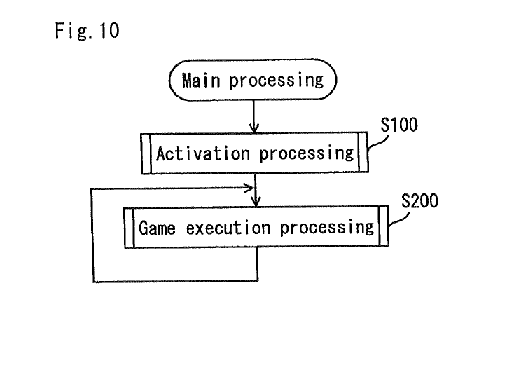

FIG. 10 is a flowchart showing main processing conducted in the slot machine 10.

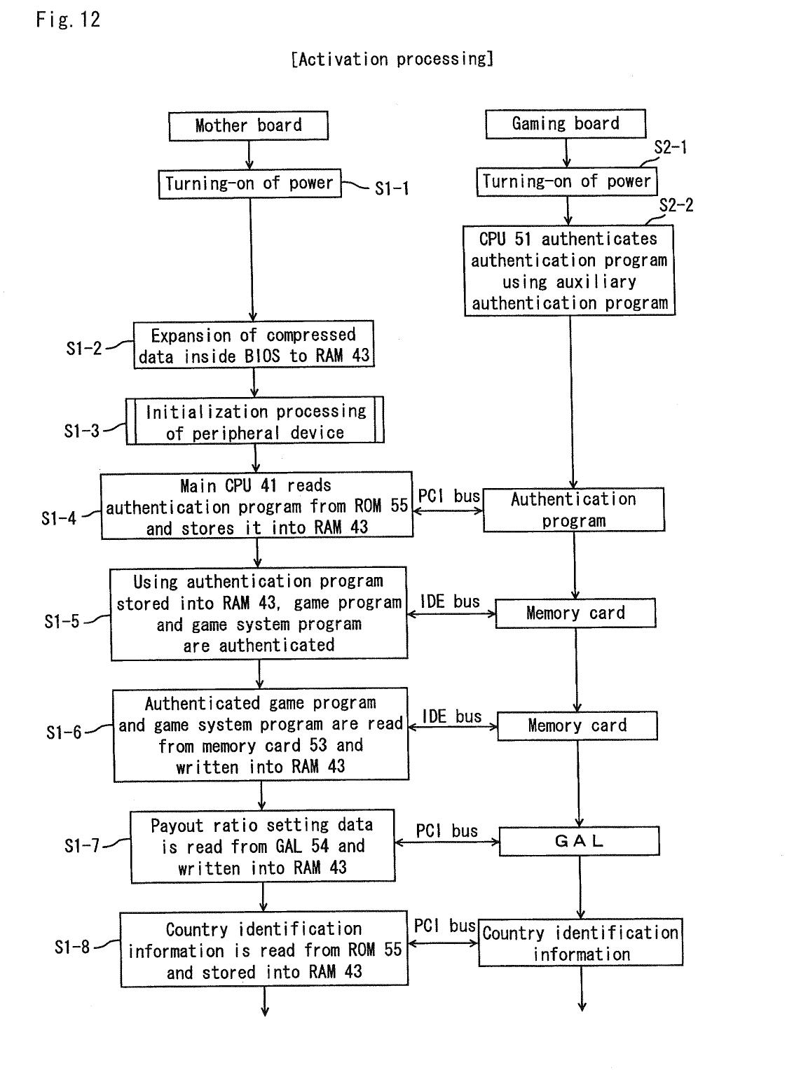

First, activation processing is conducted in the slot machine 10 (step S100). The activation processing is specifically described later by using FIG. 12.

It is to be noted that, upon receipt of a detection signal outputted from the coin counter 21C when a coin inserted into the coin receiving slot 21 is detected by the coin counter 21C after the activation processing, the main CPU 41 conducts processing for adding the amount of inserted coins to the number of credits stored in the RAM 43 as interruption processing.

After the processing of S100, the main CPU 41 repeats the game execution processing (step S200).

### [Game Execution Processing]

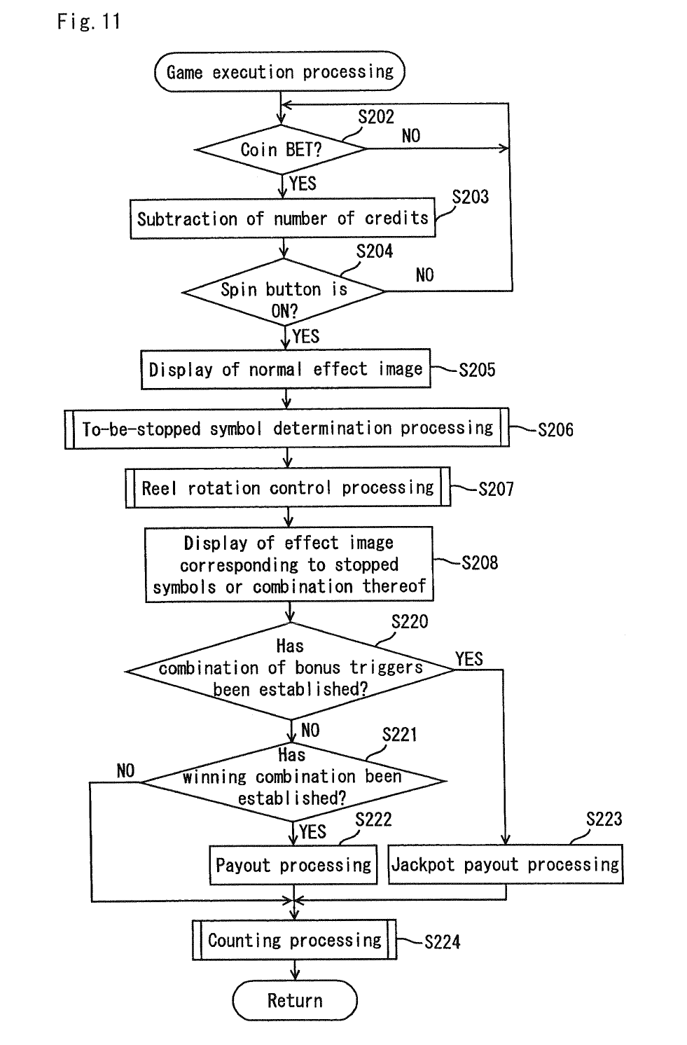

FIG. 11 is a flowchart illustrating a subroutine of the game execution processing called and executed in step S200 of the subroutine shown in FIG. 10.

First, the main CPU 41 determines whether or not a coin has been BET (step S202). In this processing, the main CPU 41 determines whether or not to have received an input signal that is outputted from the 1-BET switch 26S when the 1-BET button 26 is operated, or an input signal that is outputted from a maximum BET switch 27S when the maximum BET button 27 is operated. When the main CPU 41 determines that the coin has not been BET, the processing is returned to step S202.

On the other hand, when determining that the coin has been BET in step S202, the main CPU 41 conducts processing for making a subtraction from the number of credits stored in the RAM 43 according to the number of coins BET (step S203). It is to be noted that, when the number of coins BET is larger than the number of credits stored in the RAM 43, the main CPU 41 does not conduct the processing for making a subtraction from the number of credits stored in the RAM 43, and the processing is returned to step S202. Further, when the number of coins BET exceeds the upper limit of the number of coins that can be BET in one game (three coins in the present embodiment), the main CPU 41 does not conduct the processing for making a subtraction from the number of credits stored in the RAM 43, and the processing is proceeded to step S204.

Next, the main CPU 41 determines whether or not the spin button 23 has been turned ON (step S204). In this processing, the main CPU 41 determines whether or not to have received an input signal that is outputted from the spin switch 23S when the spin button 23 is pressed.

When the main CPU 41 determines that the spin button 23 has not been turned on, the processing is returned to step S202.

It is to be noted that, when the spin button 23 is not turned ON (e.g. when the spin button 23 is not turned ON and a command to end the game is inputted), the main CPU 41 cancels a subtraction result in step S203.

In the present embodiment, a case is described where, after a coin is BET (step S202), the processing for making a subtraction from the number of credits is conducted (step S203) before whether or not the spin button 23 has been turned ON is determined (step S204). However, the present invention is not limited to this example. For example, after a coin was BET (step S202), whether or not the spin button 23 has been turned ON may be determined (step S204), and when it is determined that the spin button 23 has been turned ON (step S204: YES), the processing for making a subtraction from the number of credits may be conducted (step S203).

On the other hand, when determining that the spin button 23 has been turned ON in step S204 in FIG. 7, the main CPU 41 conducts to-be-stopped symbol determination processing (step S206). In this to-be-stopped symbol determination processing, the main CPU 41 (arithmetic processing unit) executes a to-be-stopped symbol determination program stored in the RAM 43 (storage device) so as to determine a code No. in stopping each of the reels 14. Thereby, a combination of symbols to be rearranged is determined. This processing will be specifically described later by using FIG. 15 and FIG. 18. It should be noted that, in the present embodiment, a case is described where a combination of symbols to be rearranged is determined so as to determine one winning combination out of a plurality of types of winning combinations. However, in the present invention, for example, a random number may be used first so as to determine one winning combination to be selected randomly from the plurality of types of winning combinations, and thereafter, a combination of symbols to be rearranged may be determined based on the above-mentioned winning combination.

Next, the main CPU 41 conducts reel rotation control processing (step S207).

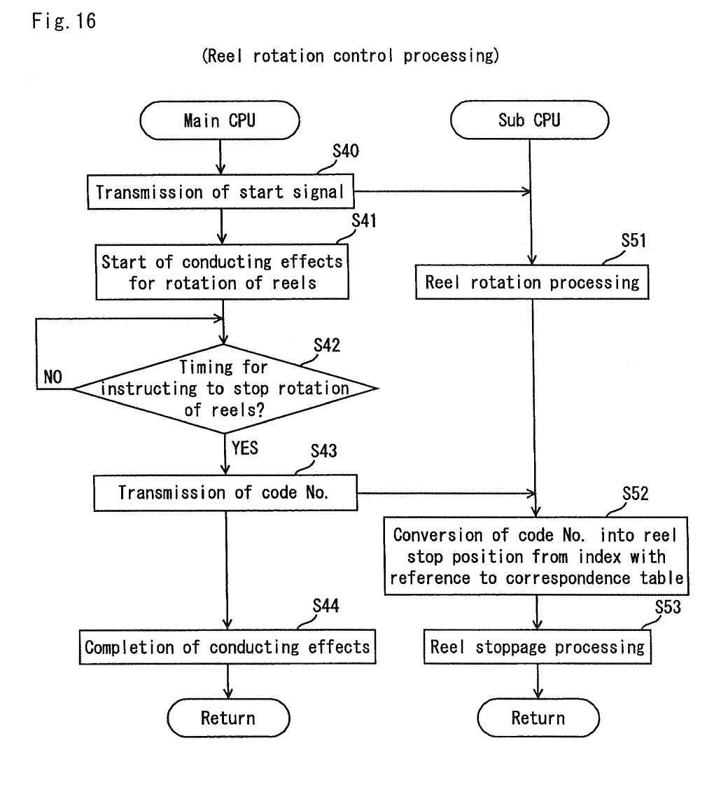

This is the processing for starting rotation of all the reels 14 and then stopping rotation of the reels 14 so that the combination of symbols corresponding to the winning combination determined in step S206 is rearranged along the winning line L. This processing will be specifically described later by using FIG. 16 to FIG. 18.

Next, the main CPU 41 determines whether or not a combination of bonus triggers has been established (step S220). When it is determined that the combination of bonus triggers has been established, a single jackpot is selected out of four types of jackpots “GRAND”, “MAJOR”, “MINOR” and “MINI” by using a random number, and the number of coins set with respect to the selected jackpot is paid out (step S223). In the case of accumulating coins, the main CPU 41 conducts processing for adding a predetermined number of credits to the number of credits stored in the RAM 43. On the other hand, in the case of paying out coins, the main CPU 41 transmits a control signal to the hopper 66 in order to pay out a predetermined number of coins. At that time, the coin detecting portion 67 counts the number of coins paid out from the hopper 66, and when the counted value reaches a designated number, the coin detecting portion 67 transmits a payout completion signal to the main CPU 41. Thereby, the main CPU 41 stops driving of the hopper 66 and ends the coin payout processing. Thereafter, the processing is shifted to step S224.

On the other hand, in step S220, when determining that the combination of bonus triggers has not been established, the main CPU 41 determines whether or not a winning combination has been established (step S221). When determining that the winning combination has been established, the main CPU 41 pays out coins according to the number of BETs and the winning combination (step S222). When it is determined that any of winning combinations has not been established in step S221, or when the processing of step S222 has been executed, the processing is shifted to step S224.

In step S224, the main CPU 41 executes the counting processing, and terminates the present subroutine. The counting processing has been already described by using FIG. 1 and the description will not be repeated here.

### [Activation Processing]

FIG. 12 is a flowchart showing a procedure of activation processing called and executed in step S100 of the flowchart shown in FIG. 10. This activation processing is the processing conducted by the mother board 40 and the gaming board 50. It should be noted that the memory card 53 is inserted into the card slot 53S in the gaming board 50, and the GAL 54 is mounted onto the IC socket 54S.

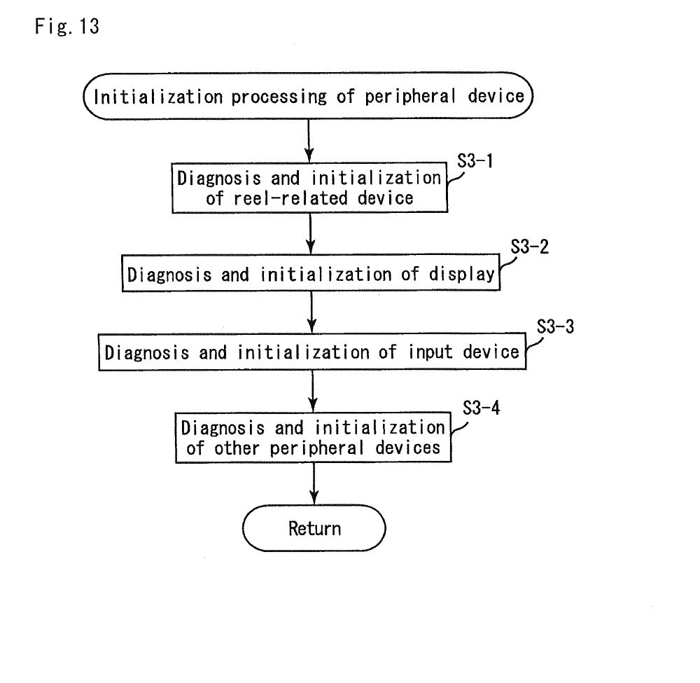

First, when a power switch is turned on (power is turned on) in the power supply unit 45, the mother board 40 and the gaming board 50 are activated (steps S1-1, S2-1). Inactivation of the mother board 40 and the gaming board 50, individual processing is respectively executed in parallel. Namely, in the gaming board 50, the CPU 51 reads the auxiliary authentication program stored in the boot ROM 52, and conducts auxiliary authentication according to the read auxiliary authentication program, to previously check and prove that the authentication program is not falsified before loading the program to the mother board 40 (step S2-2). Meanwhile, in the mother board 40, the main CPU 41 executes the BIOS stored in the ROM 42, and expands compressed data which is incorporated in the BIOS into the RAM 43 (step S1-2). The main CPU 41 then executes the BIOS expanded into the RAM 43 to diagnose and initialize a variety of peripheral devices (step S1-3). The processing of step S1-3 will be specifically described later with reference to FIG. 13.

Since the ROM 55 of the gaming board 50 is connected to the main CPU 41 via the PCI bus, the main CPU 41 reads the authentication program stored in the ROM 55, and stores the read authentication program into the RAM 43 (step S1-4). At this time, according to the standard BIOS function of BIOS, the main CPU 41 takes a checksum by ADDSUM system (normal checking system) and stores the authentication program into the RAM 43, while conducting processing for confirming whether or not the storage is certainly conducted.

Next, after confirming what is connected to the IDE bus, the main CPU 41 accesses, via the IDE bus, the memory card 53 inserted, in the card slot 53S, to read a game program or a game system program from the memory card 53. In this case, the main CPU 41 reads data constituting the game program and the game system program by 4 bytes. Subsequently, the main CPU 41 conducts authentication to check and prove that the read game program and game system program have not been falsified, following the authentication program stored in the RAM 43 (step S1-5). When this authentication processing is normally completed, the main CPU 41 writes and stores the game program and the game system program, which have been the authentication targets (which have been authenticated), into the RAM 43 (step S1-6). Next, the main CPU 41 accesses, via the PCI bus, the GAL 54 mounted on the IC socket 54S, reads payout ratio setting data from the GAL 54, and writes and stores the data into the RAM 43 (step S1-7). Subsequently, the main CPU 41 conducts processing for reading country identification information stored in the ROM 55 of the gaming board 50 via the PCI bus, and writes and stores the read country identification information into the RAM 43 (step S1-8).

After conducting the above-mentioned processing, the main CPU 41 sequentially reads and executes the game program and the game system program, thereby execute the processing shown in FIG. 10 and FIG. 11.

FIG. 13 is a chart illustrating a procedure of peripheral-device initialization processing.

First, the main CPU 41 diagnoses and initializes a reel-related device (step S3-1). In this processing, the main CPU 41 sequentially transmits request signals to the index detecting circuit 65, the position-change detecting circuit 71, and the motor driving circuit 62. Then, the main CPU 41 determines whether or not to have received predetermined response signals and conducts clearance of a predetermined storage area, and the like.

Next, the main CPU 41 diagnoses and initializes a display (step S3-2). In this processing, the main CPU 41 transmits the request signal to the graphic board 68. Then, the main CPU 41 determines whether or not to have received a predetermined response signal and conducts clearance of a predetermined storage area, and the like.

Next, the main CPU 41 diagnoses and initializes various types of input devices (step S3-3). In this processing, the main CPU 41 transmits request signals to the input devices such as the spin switch 23S, the change switch 24S, the CASHOUT switch 25S, the 1-BET switch 26S, the maximum BET switch 27S, and the touch panel 11, and then determines whether or not to have received predetermined response signals.

Subsequently, the main CPU 41 diagnoses and initializes other peripheral devices connected to the main CPU 41 (step S3-4). Then the present subroutine is terminated.

Here, activation processing of the control device will also be described.

### [Activation Processing]

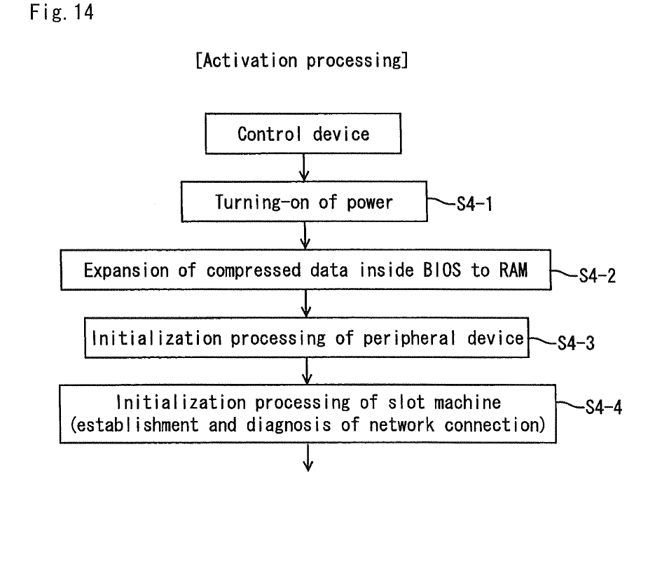

FIG. 14 is a chart illustrating a procedure of activation processing of the control device.

First, when the power switch is turned on (the power is turned on) in the power unit, a mother board is activated (step S4-1).

In the mother board, the CPU 201 executes a BIOS stored in the ROM 502 so as to expand compressed data incorporated in the BIOS into the RAM 503 (step S4-2). Then, the CPU 201 executes the BIOS expanded into the RAM 503, and then, diagnoses and initializes various types of peripheral devices such as the common image display 2 and the common compact image displays 3 (step S4-3).

Next, the CPU 201 executes initialization processing of each slot machine. In this processing, the CPU 201 establishes a network connection between the control device 200 and each slot machine 10, and diagnoses if the network functions properly.

After the above-described processing, the CPU 201 controls proceeding of the game executed in a plurality of the slot machines 10 by reading and executing a game control program. In particular, the CPU 201 counts the number of the specific game based on information on the combination transmitted from each slot machine 10.

### [To-Be-Stopped Symbol Determination Processing]

FIG. 15 is a flowchart showing a subroutine of the to-be-stopped symbol determination processing called and executed in step S206 of the subroutine shown in FIG. 11. This is the processing conducted such that the main CPU 41 executes the to-be-stopped symbol determination program stored in the RAM 43.

First, the main CPU 41 executes a random number generation program included in the to-be-stopped symbol determination program, to select random numbers respectively corresponding to three reels 14, out of the numbers falling in the numeric range of 0 to 255 (step S31). In the present embodiment, the case of generating random numbers on the program (the case of using a so-called software random number) is described. However, in the present invention, a random number generator may be provided and random numbers may be extracted from the random number generator (a so-called hardware random number may be used).

Next, the main CPU 41 (arithmetic processing unit) determines a code No. (see FIG. 18) of the respective reels 14 based on the selected three random numbers, by referring to symbol weighing data according to the payout ratio setting data outputted from the GAL 54 and stored in the RAM 43 (storage device) (step S32). The code Nos. of the respective reels 14 correspond to code Nos. of symbols to be rearranged along the winning line L. It should be noted that later-described reel rotation control processing is conducted based on these code Nos. of the reels.

### [Reel Rotation Control Processing]

FIG. 16 is a flowchart showing the reel rotation control processing called and executed in step S207 of the subroutine shown in FIG. 11. It is to be noted that this is the processing conducted between the main CPU 41 and the sub CPU 61.

First, the main CPU 41 transmits to the sub CPU 61 a start signal to start rotation of the reels (step S40). Upon receipt of the start signal from the main CPU 41, the sub CPU 61 conducts the reel rotation processing (step S51). In this processing, the sub CPU 61 supplies a pulse to the motor driving circuit 62. The pulse outputted from the sub CPU 61 is amplified by the driver 64, and then supplied to each of the stepping motors 70 (70L, 70C, 70R). This results in rotation of each of the stepping motors 70, along with which each of the reels 14 (14L, 14C, 14R) is rotated. In the one-two phase excitation stepping motor 70, a step angle is 0.9 degrees and the number of steps per rotation is 400. Therefore, when 400 pulses are supplied to the stepping motor 70, the reels 14 rotate one turn.

In starting rotation of the reels 14, the sub CPU 61 supplies a low frequency pulse to the motor driving circuit 62, and gradually increases the pulse frequency. Along with this, a rotational speed of the reels 14 increases. After a lapse of a predetermined period of time, the pulse frequency is made constant. This results in rotation of the reels 14 at a constant speed.

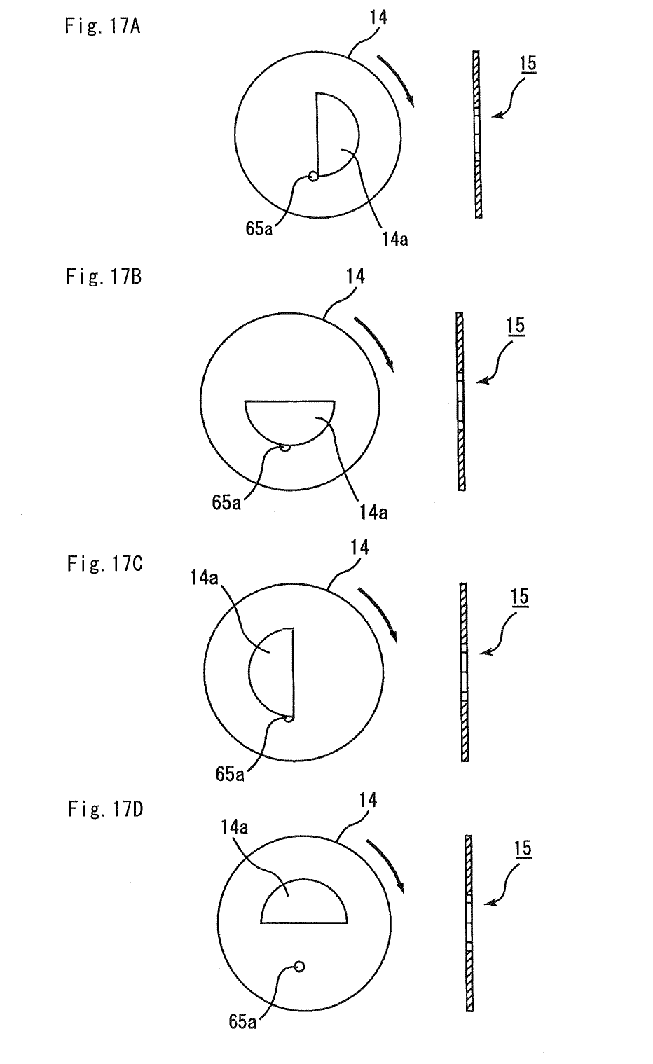

Here, the rotational operation of the reels 14 is described by using FIGS. 17A to 17D.

FIGS. 17A to 17D are side views for explaining the rotational operation of each of the reels 14.

As shown in FIG. 17A, a semicircular metal plate 14a is provided on the side face of each of the reels 14. The metal plate 14a is rotated along with each of the reels 14. Further, 22 symbols are provided on the peripheral face of each of the reels 14. Three symbols out of the 22 symbols drawn on the peripheral face of each of the reels 14 become visually identifiable via the display window 15 formed in front of each of the reels 14. In the figure, heavy-line arrows indicate the rotational direction of each of the reels 14. Further, an adjacent sensor 65a is provided on the side face of each of the reels 14. The adjacent sensor 65a is for detecting the metal plate 14a. The adjacent sensor 65a does not move or rotate along with rotation of each of the reels 14.

FIG. 17A shows a position (hereinafter also referred to as position A) of the metal plate 14a at the time of becoming detected by the adjacent sensor 65a. When each of the reels 14 rotates with the metal plate 14a located in the position A, the metal plate 14a moves to a position shown in FIG. 17B. FIG. 17B shows a position (hereinafter also referred to as position B) of the metal plate 14a at the time of being detected by the adjacent sensor 65a. When each of the reels 14 rotates with the metal plate 14a located in the position B, the metal plate 14a moves to a position shown in FIG. 17C. FIG. 17C shows a position (hereinafter also referred to as position C) of the metal plate 14a at the time of becoming undetected by the adjacent sensor 65a.

When each of the reels 14 rotates with the metal plate 14a located in the position C, the metal plate 14a moves to a position shown in FIG. 17D. FIG. 17D shows a position (hereinafter also referred to as position D) of the metal plate 14a at the time of being not detected. When each of the reels 14 rotates with the metal plate 14a located in the position D, the metal plate 14a returns to the position A. As thus described, the position of the metal plate 14a changes sequentially from the position A, the position B, the position C, the position D, the position A, and so forth, along with rotation of each of the reels 14.

The adjacent sensor 65a constitutes the index detecting circuit 65 (see FIG. 5). Assuming that the state where the adjacent sensor 65a is detecting the metal plate 14a is referred to as “High” and the state where the adjacent sensor 65a is not detecting the metal plate 14a is referred to as “Low”, the index detecting circuit 65 is in the “High” state when the metal plate 14a is located in the position A→the position B→the position C, and the index detecting circuit 65 is in the “Low” state when the metal plate 14a is located in the position C→the position D→the position A. It is to be noted that the sub CPU 61 identifies the rotational position of each of the reels 14 such that a leading edge from “Low” to “High” as index (original point) 1 and a falling edge from “High” to “Low” as index (original point) 2.

After transmitting a start signal to the sub CPU 61 in step S40, the main CPU 41 executes effects in rotation of the reels (step S41). This is the processing for displaying an image to the lower image display panel 16, outputting sound from the speaker 29, and the like, during a period (e.g. 3 seconds) set according to a result of the to-be-stopped symbol determination processing (FIG. 11, step S206) or the like.

Next, the main CPU 41 determines whether or not the current time point is the timing for instructing to stop rotation of the reels 14 (step S42).

Here, the timing for instructing to stop rotation of the reels 14 is the timing before the time point of stopping the performance of effects in rotation of the reels only by the minimum time required for stopping rotation of the reels 14. It is to be noted that the minimum time required for stopping rotation of the reels 14 is previously set.

In step S42, when determining that the current time point is not the timing for instructing to stop rotation of the reels 14, the main CPU 41 returns the processing to step S42, and continuously executes the performance of effects in rotation of the reels. On the other hand, when determining that the current time point is the timing for instructing to stop rotation of the reels 14 in step S42, the main CPU 41 transmits code No. stored in the RAM 43 to the sub CPU 61 (step S43).

In this processing, the main CPU 41 sequentially transmits code No. of the reel 14L, code No. of the reel 14C, and the code No. of reel 14R to the sub CPU 61 at predetermined time intervals.

Upon receipt of code No. of the reels from the main CPU 41, the sub CPU 61 converts code No. into the stop position (the number of steps) of each reel from the index, based on the correspondence table of the number of steps stored in ROM (not shown) provided in the sub CPU 61 and code No. (step S52).

FIG. 18 is a schematic view showing a correspondence table of the number of steps and code No. Each code No. is associated with index and the number of steps.

It should be noted that each code No. corresponds to a symbol drawn on the peripheral face of each of the reels 14. Symbols of code No. “00” to “10” correspond to index 1. Symbols of code No. “11” to “21” correspond to index 2. Further, the numbers of steps in the correspondence table shown in FIG. 18 are the numbers of steps set by regarding index 1 as a reference. For example, when code No. is “08”, a position 145 steps from index 1 is the stop position of the reel. Further, when code No. is “12”, a position 218 steps from index 1 is the stop position of the reel.

Next, the sub CPU 61 executes a reel stoppage processing (step S53). In this processing, the sub CPU 61 detects the leading edge (index 1) from “Low” to “High” of each reel 14 in the index detecting circuit 65, and supplies the index detecting circuit 65 with pulses corresponding to the number of steps into which code No. has been converted in step S52, at the timing of detecting index 1, and thereafter, the supply of the pulse is stopped.

For example, when it is determined that the stop position of the reel is a position 145 steps away from index 1 in step S52, the sub CPU 61 supplies the index detecting circuit 65 with 145 pulses at the timing of detecting index 1, and then stops the supply of the pulse. Further, in step S52, when it is determined that the stop position of the reel is a position 218 steps away from index 1, the sub CPU 61 supplies the index detecting circuit 65 with 218 pulses at the timing of detecting index 1. As a result, the reels 14 stop with the code numbers as determined in step S32 in FIG. 15, and a combination of symbols corresponding to the winning combination determined in step S32 in FIG. 15 is rearranged along the winning line L. Meanwhile, the main CPU 41 ends the performance of effects in rotation of the reels. After completing the processing of steps S44 and S53, the present processing is terminated.

When index corresponding to code No. transmitted in step S43 differs from index detected by the index detecting circuit 65 in stopping rotation of the reels 14, a loss of synchronism has occurred in the reels 14, and therefore, the main CPU 41 conducts processing for displaying an error message to the lower image display panel 16, or the like, to discontinue the game.

For example, when the index 1 is detected by the index detecting circuit 65 in stopping rotation of the reel 14L although the main CPU 41 conducts the processing for stopping reel 14L at code No. 12 which corresponds to index 2, the game is discontinued.

As just described, according to the link system 1 and the control method thereof, in the control device 200, there is cumulatively counted the number of the specific game in which a combination of symbols stop-displayed to the reels 14 of each of the slot machines 10 is a specific combination. Then, when the number of the specific game has reached the predetermined number, a payout signal is transmitted to the slot machines 10. In each of the slot machines 10, payout of a predetermined number of coins is conducted when the payout signal is received from the control device 200. Accordingly, it becomes possible to form fellowship among the players playing on the respective slot machines 10, to cooperate to make the number of the specific game reach the predetermined number. Consequently, it becomes possible to relieve the loneliness.

Further, according to the link system 1, payout of the predetermined number of coins is conducted in all the slot machines 10 (three, in the present embodiment) when the number of the specific game has reached the predetermined number. Therefore, it becomes possible for the players playing on the respective slot machines 10 to share the delight.

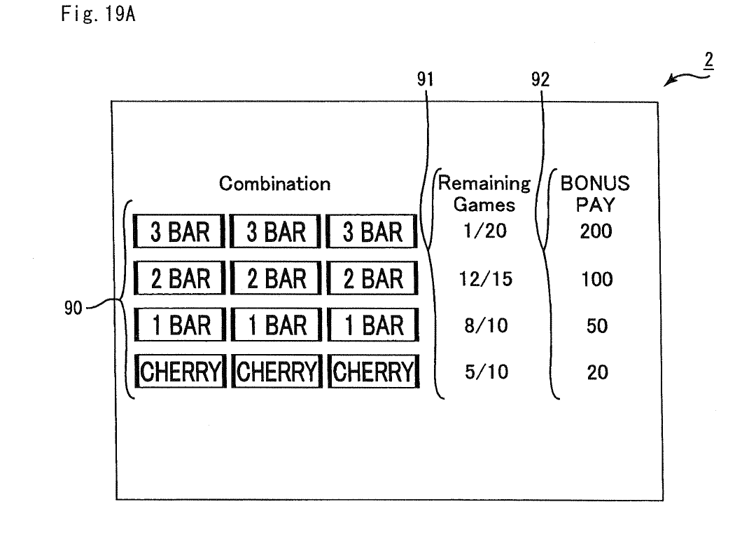

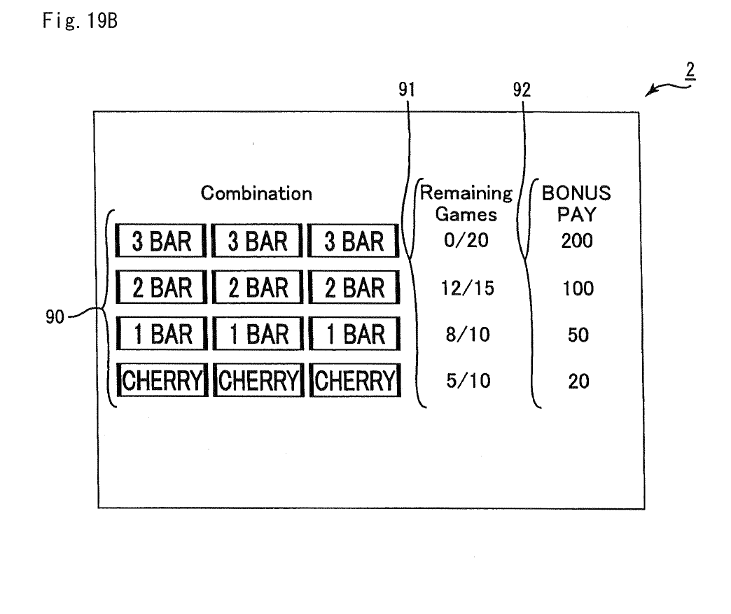

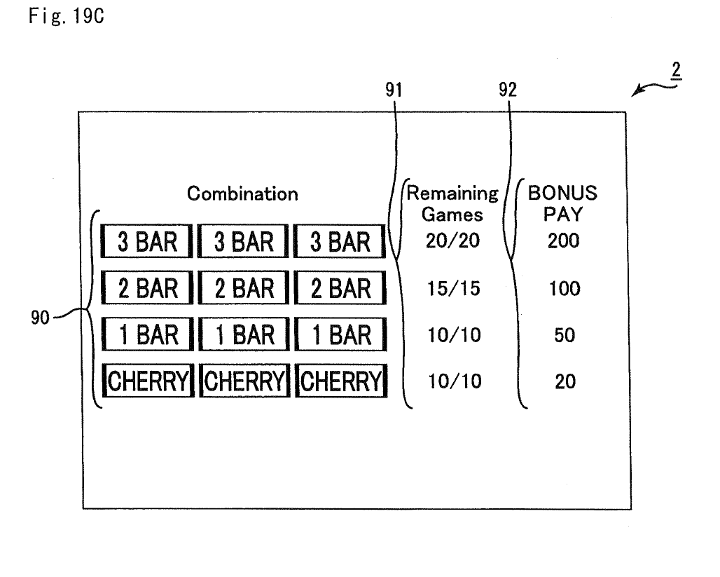

In the above-described embodiment, there has been described a case where only the number of the specific game corresponding to a single specific combination having reached the predetermined number is reset, and the number of the specific game corresponding to another specific combination not having reached the predetermined number is not reset. However, in the present invention, when the number of the specific game corresponding to a single specific combination (specific state) has reached the predetermined number, there may be reset both the number of the specific game corresponding to a specific combination (specific state) having reached the predetermined number and the number of the specific game corresponding to another specific combination (specific state) not having reached the predetermined number. Hereinafter, a slot machine in this case will be described by using FIG. 19A to FIG. 19C.

FIG. 19A, FIG. 19B, and FIG. 19C are exemplary views of images each displayed to a common image display provided in a link system according to another embodiment of the present invention.

FIG. 19A shows an image displayed to a common image display at a certain point.

As shown in FIG. 19A, to the common image display 2, there are provided an area 90, an area 91, and an area 92. For example, to the area 91, 1/20 is displayed as “Remaining Games” of “3BAR-3BAR-3BAR”.

In a state shown in FIG. 19A, when the combination of “3BAR-3BAR-3BAR”, for example, is established at any of the three slot machines 10, the number of the specific game corresponding to the combination of “3BAR-3BAR-3BAR” reaches the predetermined number (20 times) (see FIG. 19B).

As a result, 360 coins as “BONUS PAY” of “3BAR-3BAR-3BAR” are to be paid out at all of three slot machines 10.

Thereafter, the number of the specific game of “3BAR-3BAR-3BAR” is reset. Further, the number of the specific game corresponding to the specific combination (in this example, “2BAR-2BAR-2BAR”, “1BAR-1BAR-1BAR”, “CHERRY-CHERRY-CHERRY”) having not reached the predetermined number is also reset. As a result, as shown in FIG. 19C, an image showing that all the numbers of the specific games are reset is displayed to the common image display 2.

In the above-described embodiment, there has been described a case where payout of the coin is conducted in all the slot machines 10, when the number of the specific game has reached the predetermined number. However, the present invention is not limited to this example. The payout of the game medium may be conducted only in the slot machine having executed the game which makes the number of the specific game reach the predetermined number, as it becomes possible to give a sense of superiority to the player playing on the slot machine having played the game which makes the number of the specific game reach the predetermined number.

In the above-described embodiment, there has been described a case where the counting processing (see step S224 in FIG. 11) is surely executed. However, the present invention is not limited to this example. The counting processing, namely count of the number of the specific game may be conducted only in the case that the game media is BET in number equal to the maximum number of BET. It is because that it becomes possible to encourage the player to BET the game media in the maximum number of BET. Further, it is because that the management side becomes able to increase the possibility to make more profit in a short time.

In the above-described embodiment, there has been described a case where information on the combination is transmitted to the control device 200 from each slot machine 10 in each game and the control device 200 determines whether or not the specific combination is established in the game executed in each slot machine 10. However, the present invention is not limited to this example. The slot machine may determine whether or not symbols or a combination thereof is in a specific state (specific combination), and may transmit a count signal (information according to the specific state) to the control device only in the case of determining the symbols or the combination thereof is in the specific state. It is because that a load on the control device caused by the counting processing of the number of the specific game can be reduced, and it becomes possible to connect more slot machines with the control device.

In the above-described embodiment, there has been described a case where the specific combinations are “3BAR-3BAR-3BAR”, “2BAR-2BAR-2BAR”, “1BAR-1BAR-1BAR”, and “CHERRY-CHERRY-CHERRY”. However, in the present invention, the specific state (specific combination) is not limited to this example. The specific state may be, for example, a stop state not generating payout of the game medium (e.g. “BLANK-BLANK-BLANK”). Further, the specific state may be not determined in advance, and may be determined according to time and the number of the game, out of a plurality of potential specific states by selecting a random number.

The slot machine 10 according to the present embodiment is a stand-alone type slot machine and counts the number of the specific game. However, in the present invention, the slot machine is not necessarily a stand-alone type slot machine, and a server (central controller) connected to a plurality of slot machines via a network may count the number of the specific game played in each slot machine.

In the above-mentioned example, the case of using mechanical reels 14 has been described. However, in the present invention, symbols may be displayed to a display device such as a liquid crystal display in place of the mechanical reels.

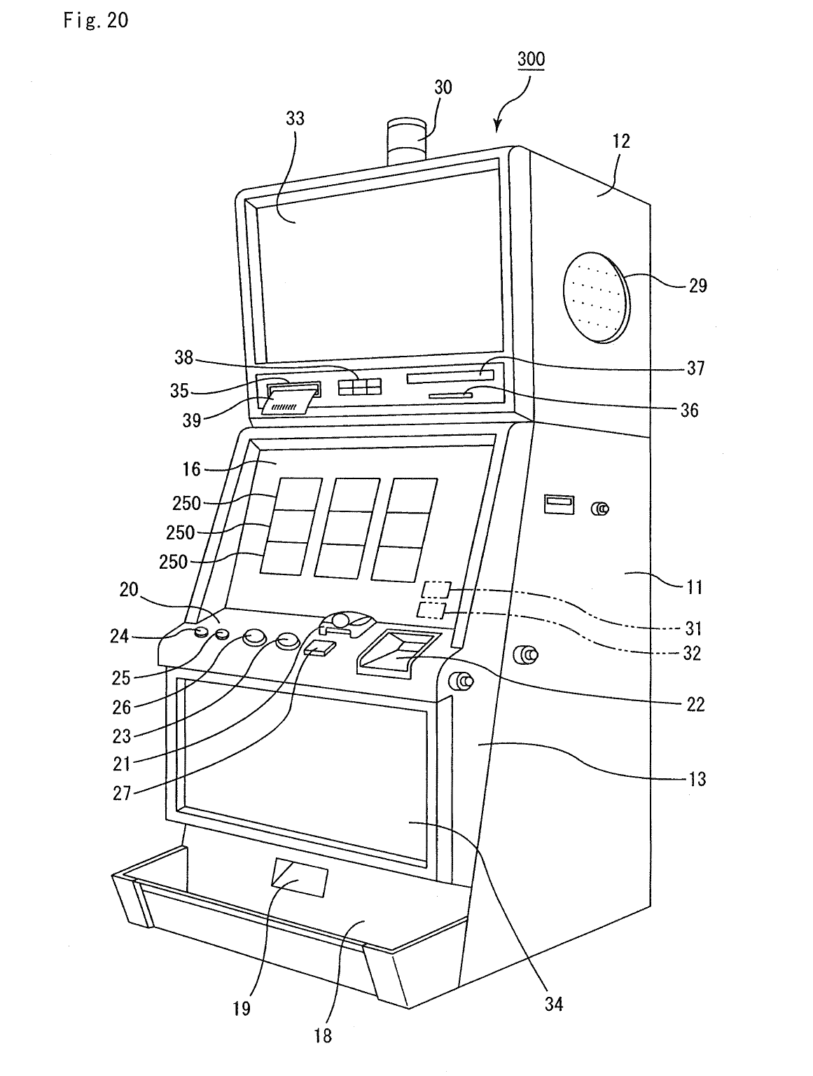

FIG. 20 is a perspective view schematically showing a slot machine according to another embodiment of the present invention.

Except for displaying symbols to a lower image display panel, a slot machine 300 has substantially the same appearance, circuit configuration and the like as those of the slot machine 10, and the flowchart of the slot machine 300 is substantially the same as that of the slot machine 10. Therefore, descriptions of the slot machine 300 are omitted except for a description of symbol display. Further, constituent elements corresponding to those of the slot machine 10 are provided with the same numerals as in the slot machine 10.

The lower image display panel 16 included in the slot machine 300 is provided with symbol display areas 250 having three columns and three rows, and one symbol is displayed in each symbol display area. In such a configuration, the scroll-display of symbols may be displayed to the lower image display panel 16 in place of the reel rotation control by the sub CPU 61.

Here, in the present invention, variable-display of symbols refers to scroll-display of symbols by using a mechanical reel as in the slot machine 10, and also refers to display of symbols in a state of scrolling by using a image display such as a liquid crystal display as in the slot machine 300.

Although the embodiments of the present invention were described above, they were just illustrations of specific examples, and hence do not particularly restrict the present invention. A specific configuration of each step and the like is appropriately changeable in terms of design. Further, the effects described in the embodiments of the present invention are just recitations of the most suitable effects generated from the present invention. The effects of the present invention are thus not limited to those described in the embodiments of the present invention.

Further, the foregoing detailed descriptions centered the characteristic parts of the present invention in order to facilitate understanding of the present invention. The present invention is not limited to the embodiments in the foregoing specific descriptions but applicable to other embodiments with a variety of application ranges. Further, terms and phrases in the present specification were used not for restricting interpretation of the present invention but for precisely describing the present invention. It is considered easy for the skilled in the art to conceive other configurations, systems, methods and the like included in the concept of the present invention from the concept of the invention described in the specification. Therefore, it should be considered that recitations of the claims include uniform configurations in a range not departing from the range of technical principles of the present invention. Moreover, an object of the abstract is to enable a patent office, a general public institution, an engineer belonging to the technical field who is unfamiliar with patent, technical jargon or legal jargon, and the like, to smoothly determine technical contents and an essence of the present application with simple investigation. Accordingly, the abstract is not intended to restrict the scope of the invention which should be evaluated by recitations of the claims. Furthermore, for thorough understanding of an object of the present invention and an effect specific to the present invention, it is desired to make interpretation in full consideration of documents already disclosed and the like.

The foregoing detailed descriptions include processing executed on a computer or a computer network. Explanations and expressions above are described with the aim of being most efficiently understood by the skilled person in the art. In the specification, each step for use in deriving one result should be understood as the self-consistent processing. Further, in each step, transmission/reception, recording or the like of an electrical or magnetic signal is performed. While such a signal is expressed by using a bit, a value, a symbol, a letter, a term, a number or the like in processing of each step, it should be noted that those are used simply for the sake of convenience in description. While there are cases where processing in each step may be described using an expression in common with that of action of a human, processing described in the specification is essentially executed by a variety of devices. Further, another configuration requested for performing each step should become apparent from the above descriptions.

What is claimed as new and desired to be secured by letters patent of the United States is:

1. A gaming system comprising:
a plurality of slot machines each provided with a symbol display capable of variably displaying a plurality of symbols, and a controller;
a control device provided with a processor; and
a network enabling a communication between said plurality of slot machines and said control device,
said controller programmed to execute the processing of
(a) executing repeatedly processing of stop-displaying said plurality of symbols after variably displaying said plurality of symbols, to said symbol display,
said processor programmed to execute the processing of
(A) counting cumulatively a number of a specific game in which the plurality of symbols stop-displayed to said symbol display of each of said slot machines or a combination of the plurality of symbols is in a specific state, and
(B) transmitting a payout signal to said slot machines when said number of the specific game has reached a predetermined number, and
said controller further programmed to execute the processing of
(b) conducting a payout of a predetermined number of game media when receiving said payout signal from said control device.

2. The gaming system according to claim 1,
wherein
said controller is further programmed to execute the processing of
(a-1) transmitting a count signal to said control device, in a case where the plurality of symbols stop-displayed to said symbol display or the combination of the plurality of symbols is in the specific state, and
said processing (A) executed by said processor is a processing of
counting cumulatively said number of the specific game based on receipt of said count signal.

3. The gaming system according to claim 1,
wherein
said processing (a) executed by said controller is a processing of
executing repeatedly processing of stop-displaying said plurality of symbols after variably displaying said plurality of symbols, to said symbol display, on condition that the game media is BET in number equal to or less than the predetermined maximum number of BET, and
said processing (A) executed by said processor is a processing of
counting cumulatively said number of the specific game in which the game media is BET in number equal to said maximum number of BET and the plurality of symbols stop-displayed to said symbol display or a combination of the plurality of symbols is in a specific state, in each of said slot machines.

4. A game system comprising:
a plurality of slot machines each including a symbol display capable of variably displaying a plurality of symbols, and a controller;
a control device provided with a processor; and
a network enabling a communication between said plurality of slot machines and said control device,
said controller programmed to execute the processing of
(a) executing repeatedly processing of stop-displaying said plurality of symbols after variably displaying said plurality of symbols, to said symbol display,
said processor programmed to execute the processing of
(A) counting cumulatively a number of a specific game in which the plurality of symbols stop-displayed to said symbol display of each of said slot machines or a combination of the plurality of symbols is in a specific state, and
(B) transmitting a payout signal to all of said plurality of slot machines when said number of the specific game has reached a predetermined number, and
said controller further programmed to execute the processing of
(b) conducting a payout of a predetermined number of game media when receiving said payout signal from said control device.

5. A gaming system comprising:
a plurality of slot machines each including a symbol display capable of variably displaying a plurality of symbols, and a controller;
a control device provided with a processor; and
a network enabling a communication between said plurality of slot machines and said control device,
said controller programmed to execute the processing of
(a) executing repeatedly processing of stop-displaying said plurality of symbols after variably displaying said plurality of symbols, to said symbol display,
said processor programmed to execute the processing of
(A) counting cumulatively a number of a specific game in which the plurality of symbols stop-displayed to said symbol display of each of said slot machines or a combination of the plurality of symbols is in a specific state, and
(B) transmitting, when said number of the specific game has reached a predetermined number, a payout signal to said slot machine having executed the game which makes said number of the specific game reach said predetermined number, and
said controller further programmed to execute the processing of
(b) conducting a payout of a predetermined number of game media when receiving said payout signal from said control device.

6. A game control method comprising the steps of
(a) executing in a slot machine repeatedly processing of stop-displaying a plurality of symbols after variably displaying said plurality of symbols, to said symbol display,
(A) counting in a control device cumulatively a number of a specific game in which the plurality of symbols stop-displayed to said symbol displays of said respective slot machines or a combination of the plurality of symbols is in a specific state,
(B) transmitting from said control device a payout signal to said slot machine when said number of the specific game has reached a predetermined number, and
(b) conducting a payout of a predetermined number of game media in said slot machine when receiving said payout signal from said control device.
